(19) United States
(12) Patent Application Publication
(10) Pub. No.: US 2003/0128801 A1
(43) Pub. Date: Jul. 10, 2003

(54) Multi-modality apparatus for dynamic anatomical, physiological and molecular imaging

(75) Inventors: Harvey C. Eisenberg, Newport Beach, CA (US); William K. McCroskey, Solon, OH (US); David P. Rohler, University Heights, OH (US); David S. Vickers, Independence, OH (US); Frank T. Bradshaw, Shaker Heights, OH (US); Donald R. Ouimette, Plantsville, CT (US); Joseph S. Deucher, Lyndhurst, OH (US)

Correspondence Address: Harvey C. Eisenberg, Multi-Dimensional Imaging, Inc., 400 Newport Center Drive, Suite #100, Newport Beach, CA, 92660, US

(73) Assignee: Multi-Dimensional Imaging, Inc.

(21) Appl. No.: 10/039,128

(22) Filed: Jan. 7, 2002

(51) Int. Cl. G21K 1/12; H05G 1/60

(52) U.S. Cl. 378/19

(57) ABSTRACT

A multi-modality imaging system that can be utilized in the volume computed tomography (VCT) mode, the single photon emission computed tomography (SPECT) mode and the positron emission tomography (PET) mode is disclosed. In the VCT mode of operation, three (3) x-ray sources and associated detectors can be utilized. In the SPECT and PET modes of operation, the gamma radiation is provided by an isotope ingested by the patient and is detected by the detectors angularly spaced around the patient. A fused imaging analysis and computer aided diagnosis system is provided and processes the images produced by the multi-modality imaging system. The fused images are analyzed and the fused image data are compared with disease process models to provide feedback to the patient and medical professionals in the form of four dimensional displays and interactive image visualizations.

### TECHNICAL FIELD

The present invention relates, in general, to a multi-modality imaging system and, more particularly, to a computed tomography system that can be readily operated in the volume computed tomography mode, the digital radiography mode, the single photon emission computed tomography mode and the positron emission tomography mode.

### BACKGROUND ART

Since its inception, computerized tomography (CT) has held the promise of better and more accurate diagnostic information as to the anatomy of a person. Similarly, positron emission tomography (PET) and nuclear medicine/single photon emission computed tomography (NM/SPECT) technologies have advanced medical knowledge in the area of molecular and functional diagnostic techniques. Medical practitioners, faced with a surfeit of information from these various diagnostic modalities, have always envisioned a situation in which the information from all of these modalities could be brought together for one all encompassing diagnosis. CT and digital radiography (DR) could provide anatomical and registration information while PET and NM/SPECT could provide functional and molecular information. Unfortunately, the technology did not exist that could provide the requisite information.

The advent of picture archiving communication systems (PACS) provided the ability to handle the diagnostic images from disparate modalities using a compatible format. Images from all modalities could be viewed using the same diagnostic software. This was a significant advancement, however, it still did not provide the comprehensive diagnostic information that medical professionals desired. These professionals wanted to fuse images from the various modalities so that CT information would provide anatomical information to precisely locate the functional information provided by PET and NM/SPECT images. Recent advances in multi-slice CT machines have started to provide volume anatomical data that can be used with PET/SPECT images to provide a more complete diagnostic description of the patient. The limited Z-axis width of the detector arrays for these images cannot provide the instantaneous volume information needed for dynamic analyses, especially in cardiac studies.

In view of the foregoing, it has become desirable to develop a multi-modality imaging device that can be operated in the volume computed tomography (VCT) mode, the digital radiography mode, the single photon emission tomography mode and the positron emission tomography mode in order to provide anatomical, physiological and molecular information regarding the patient.

### SUMMARY OF THE INVENTION

The present invention solves the problems associated with prior art systems by providing a true volume CT device that incorporates PET and NM/SPECT capabilities for molecular and functional imaging. The present invention comprises a multi-modality imaging system and an associated multi-modality, fused imaging analysis and computer aided diagnosis system. The multi-modality imaging system can be readily utilized in three operational modes, viz., volume computed tomography (VCT), nuclear medicine/single photon emission computed tomography (NM/SPECT) and positron emission tomography (PET). The computed tomography system of the present invention utilizes a multi-headed source and detection system. Ideally, three (3) x-ray sources and associated detectors are utilized in the VCT mode of operation. In the NM/SPECT and PET modes of operation, the gamma ray radiation is produced by an isotope ingested by the patient and is detected by the detectors angularly spaced around the patient. In any mode of operation, the multi-modality tomography system of the present invention produces images having high contrast and high resolution.

The multi-modality, fused imaging analysis and computer aided diagnosis system processes the images from the multi-modality imaging system. The wide Z-axis area detector provides isotropic images in sub-second time thereby allowing for dynamic studies of the processes within the body. The images from the various modalities are fused providing a complete anatomical and physiological description of the patient. The fused images are analyzed and the fused image data are compared with disease process models and general population reference standards to provide feedback to the patient and medical professionals in the form of four dimensional displays and interactive image visualizations. The fused image data are quantified and compared to disease models which, in turn, provide probable diagnosis, preventive medicine guidance and general medicine therapy regimens.

The present multi-modality system is also capable of working with interventional techniques, such as VCT, PET and NM/SPECT needle guided biopsy, minimally invasive surgery and trauma therapy and intervention.

### BRIEF DESCRIPTION OF THE DRAWINGS

FIG. 1 is an overall block diagram of the dynamic multi-modality fused imaging, analysis, and computer aided diagnosis system of the present invention.

FIG. 2 is a perspective view of the multi-modality imaging system of the present invention utilizing a plurality of x-ray sources and associated focused two-dimensional curved detector arrays.

FIG. 3 is a block diagram of the multi-modality imaging system and the multi-modality fused imaging, analysis, and computer aided diagnosis system of the present invention.

FIG. 4 is a perspective view of an x-ray source and its associated focused two-dimensional curved detector array attached to a rotate plate and utilized in the multi-modality imaging system of the present invention.

FIG. 5 includes a series of views illustrating the cone beam shaped compensation filter and the source collimator for each x-ray source utilized by the multi-modality imaging system of the present invention.

FIG. 6 includes a series of views illustrating the differences between a V-groove type x-ray anode versus a slanted type x-ray anode and focused two-dimensional curved detector x-ray optics.

FIG. 7 is a series of views depicting two-dimensional focal spot dithering for improved cone beam spatial resolution.

FIG. 8 includes a series of views, including a perspective view, of the focused two-dimensional curved detector module utilized by the present invention.

FIG. 9 illustrates a focused two-dimensional curved detector array utilized by the present invention and shows an adaptive shaped x-ray optical response for same by adjusting the spatial resolution response function.

FIG. 10 includes a series of views illustrating that the focused two-dimensional curved detector array utilized by the present invention can be operated in the x-ray mode, the PET mode, and the NM/SPECT mode.

FIG. 11 illustrates the x-ray anti-scatter collimator within the detector module as used in the x-ray mode and the NM/SPECT mode of operation.

FIG. 12 includes a series of block diagrams illustrating the signal processing of the x-ray, gamma ray, area (XGA) detector module when the system is in the x-ray mode, the NM/SPECT mode and the PET mode of operation.

FIG. 13 is a perspective view of the multi-modality imaging system of the present invention and illustrates the imaging system when in the PET mode of operation with a PET anti-scatter baffle inserted therein.

FIG. 14 illustrates the placement of the PET anti-scatter baffle relative to the x-ray sources, the focused two-dimensional curved detector arrays and the rotate plate.

FIG. 15 illustrates the placement of the NM/SPECT collimators relative to the focused two-dimensional curved detector arrays when the system is in the NM/SPECT mode of operation.

FIG. 16 illustrates a NM/SPECT collimation ring assembly having a plurality of NM/SPECT collimators inserted therein when the system is in the NM/SPECT mode of operation.

FIG. 17 includes a perspective view and a front plan view of an x-ray source and its associated focused two-dimensional curved detector array and the NM/SPECT collimators, and illustrates the focus point for same.

FIG. 18 is an illustration of the spectrum of the multi-channel analyzer for both the SPECT Tc-99m isotope and the PET FDG-F18 isotope when used in multi-isotope scanning.

FIG. 19 illustrates x-ray detector scatter rejection with focused two-dimensional curved collimation.

FIG. 20 illustrates a configuration of the multi-modality imaging system of the present invention utilizing three (3) imaging heads and the sequencing of the x-ray sources for x-ray adaptive scatter radiation correction.

FIG. 21 includes a series of views illustrating the use of intensity modulation and demodulation of the x-ray sources and their associated focused two-dimensional curved detector arrays to reduce the effects of scattered x-ray radiation from multiple x-ray sources.

FIG. 22 illustrates the intensity modulation and demodulation of the x-ray sources and their associated focused two-dimensional curved detector arrays to reduce the effects of scattered x-ray radiation from multiple x-ray sources.

FIG. 23 illustrates “step and shoot” VCT imaging.

FIG. 24 includes a series of views illustrating the multi-modality imaging system of the present invention configured to perform spiral VCT, PET and NM/SPECT imaging.

FIG. 25 includes a series of views illustrating the multi-modality imaging system of the present invention utilizing multiple imaging heads for spiral VCT and cone beam sampling regions on a focused two-dimensional curved detector array.

FIG. 26 illustrates cone beam slant source collimation for spiral VCT imaging.

FIG. 27 includes a series of views illustrating the images produced by the multi-plane planning system utilized by the present invention.

FIG. 28 includes a series of views illustrating adaptive whole body dose control initiated by the planning system of the present invention.

FIG. 29 is a block diagram illustrating the interconnection of the dynamic control system to other major subsystems within the present invention.

FIG. 30 is a block diagram illustrating the overall retrospective gated imaging system utilized by the present invention.

FIG. 31 illustrates the gating control system utilized by the present invention in conjunction with EKG equipment.

FIG. 32 is a series of views illustrating prospective and retrospective gated data acquisition and reconstruction imaging utilized by the present invention.

FIG. 33 is a series of views illustrating gated data acquisition and retrospective cine′ dynamic cardiac imaging utilized by the present invention.

FIG. 34 illustrates PET transmission attenuation correction and scatter correction using VCT image and attenuation data.

FIG. 35 illustrates NM/SPECT transmission attenuation correction and scatter correction using VCT image and attenuation data.

FIG. 36 is a block diagram of the multi-modality imaging system and the multi-modality fused imaging, analysis, and computer aided diagnosis system of the present invention.

FIG. 37 is a block diagram illustrating the interventional image control system utilized by the present invention.

FIG. 38 is a perspective view of an embodiment of the multi-modality imaging system of the present invention with separate VCT, PET, and NM/SPECT image acquisition units and wherein the VCT unit utilizes multiple x-ray sources.

FIG. 39 is a perspective view of another embodiment of the multi-modality imaging system of the present invention with separate VCT, PET, and NM/SPECT image acquisition units and wherein the VCT unit utilizes a single x-ray source.

FIG. 40 is a perspective view of still another embodiment of the multi-modality imaging system of the present invention with separate VCT, PET, and NM/SPECT image acquisition units and wherein the VCT unit utilizes multiple x-ray sources and the focused two-dimensional curved detector array is stationary.

FIG. 41 is a perspective view of still another embodiment of the multi-modality imaging system of the present invention with a common VCT, PET, and NM/SPECT image acquisition unit and wherein the system utilizes multiple x-ray sources and the focused two-dimensional curved detector array is stationary.

FIG. 42 is a perspective view of an embodiment of the multi-modality imaging system of the present invention with separate VCT, PET, and NM/SPECT image acquisition units and wherein the VCT image acquisition unit utilizes multiple x-ray sources and further wherein the image acquisition units are housed within a common gantry.

FIG. 43 is a perspective view of another embodiment of the multi-modality imaging system of the present invention with separate VCT, PET, and NM/SPECT image acquisition units and wherein the VCT image acquisition unit utilizes a single x-ray source and further wherein the image acquisition units are housed within a common gantry.

FIG. 44 is a perspective view of still another embodiment of the multi-modality imaging system of the present invention with separate VCT, PET, NM/SPECT image acquisition units and wherein the VCT image acquisition unit utilizes multiple x-ray sources and the focused two-dimensional curved detector array is stationary and further wherein the image acquisition units are housed within a common gantry.

FIG. 45 is a perspective view of still another embodiment of the multi-modality imaging system of the present invention with separate VCT, PET, NM/SPECT image acquisition units and wherein the VCT image acquisition unit utilizes a single x-ray source and further wherein the image acquisition units are housed within a common gantry.

### DESCRIPTION OF THE PREFERRED EMBODIMENT

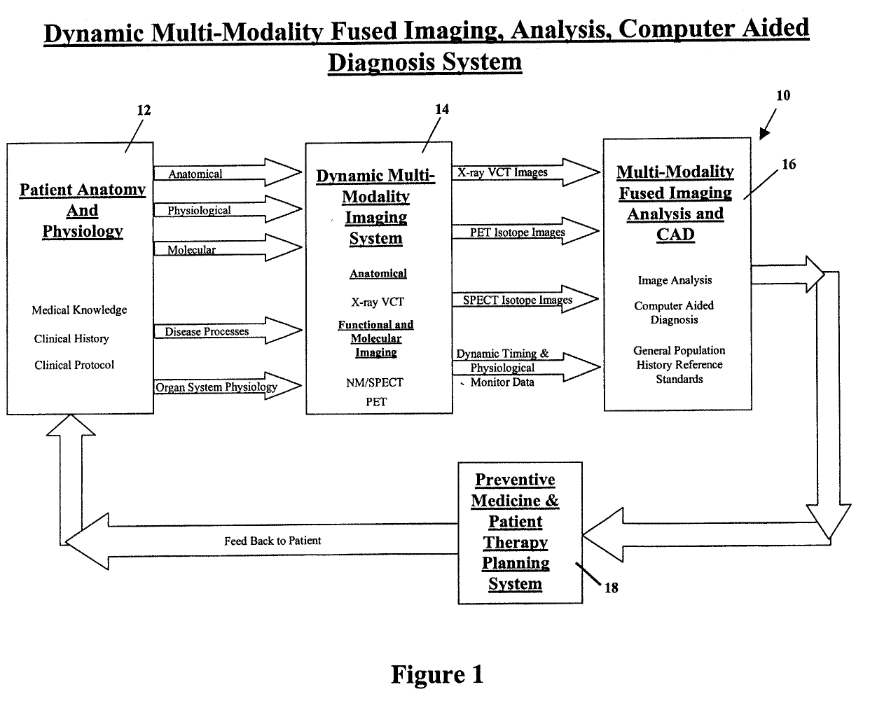

Referring now to the figures where the illustrations are for the purpose of describing the preferred embodiment of the present invention and are not intended to limit the invention disclosed herein, FIG. 1 is an overall block diagram of the dynamic multi-modality fused imaging, analysis, and computer aided diagnosis system 10 of the present invention. The system 10 provides solutions to the inherent problems associated with multi-modality fused imaging, analysis, and computer aided diagnosis. As illustrated, patient information 12 is an input in the system and includes patient anatomical, physiological and molecular information. In addition, clinical history, clinical protocol and medical knowledge are utilized as inputs in the system. The output of the patient information block 12 is typically patient anatomical, physiological and molecular data, and general knowledge of disease processes and patient organ system physiology. These outputs are utilized as inputs to a dynamic multi-modality imaging system 14 that is comprised of anatomical imaging and molecular imaging equipment. The system 14 performs anatomical imaging through the use of x-ray volume computed tomography (VCT) and digital radiography (DR) equipment. The imaging system 14 can also perform PET and NM/SPECT imaging for molecular, physiological and functional imaging. The output of the dynamic multi-modality imaging system 14 is comprised of x-ray volume computed tomography images, PET isotope images, NM/SPECT isotope images and dynamic timing and physiological monitoring data from the patient. It should be noted that both static and dynamic imaging can be performed by the imaging system 14. As used herein, static imaging refers to time independent imaging whereas dynamic imaging refers to imaging that produces imaging data as a function of time that may be triggered by temporal events. The foregoing outputs are utilized as inputs to a multi-modality fused imaging, analysis, and computer aided diagnosis system 16. This system 16 takes the inputs from the imaging system 14 and fuses the imaging data together, analyzes the fused image data, compares the fused image data with disease process models and general population reference standards, and provides “feedback” to the patient and to medical professionals in the form of four-dimensional displays and interactive image visualizations. In addition, the system 16 quantifies the fused imaging data, compares the data to disease models, and provides a probable diagnosis, preventive medicine guidance and general medical therapy solutions. The output of the multi-modality fused imaging, analysis, and computer aided diagnosis system 16 is used as an input to a preventive medicine, general medicine, and patient therapy planning system 18 which is the implementation of the “feedback” to the patient for corrective actions and therapy.

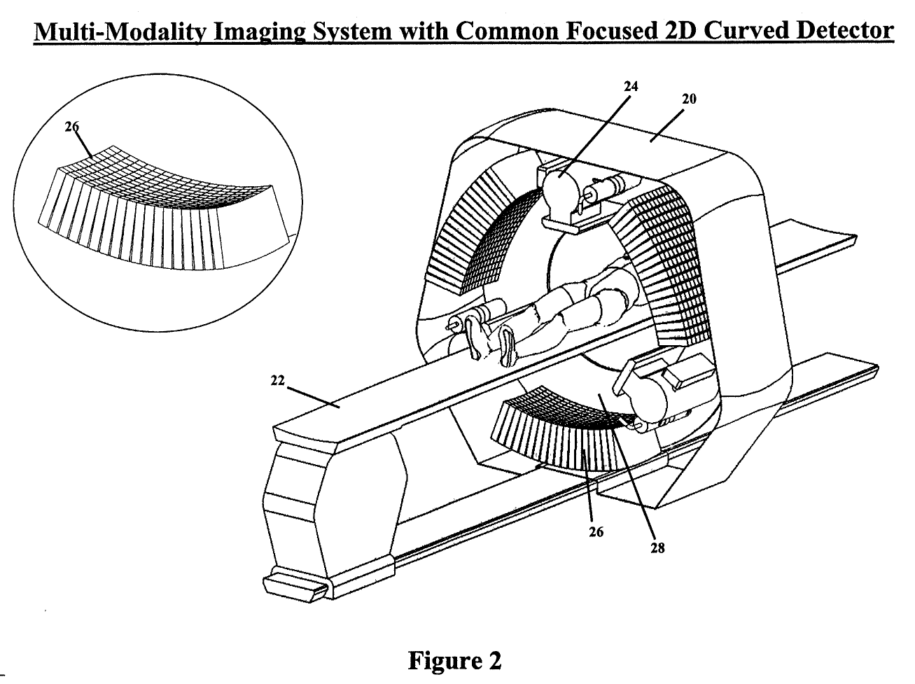

Referring now to FIG. 2, the multi-modality imaging system 14 utilizing a plurality of common focused two-dimensional curved detector arrays is illustrated. The multi-modality imaging system 14 is comprised of a gantry 20, a table 22, and three (3) x-ray sources 24 angular spaced 120 degrees apart. Each x-ray source 24 has an associated focused two-dimensional curved detector array 26 positioned directly opposite thereto. The x-ray sources 24 and the focused two-dimensional detector arrays 26 are attached to a rotate plate 28 permitting the x-ray sources 24 and the focused two-dimensional curved detector arrays 26 to rotate with respect to the gantry 20 and the table 22. The preferred x-ray source anode has a V-groove design. The gantry 20 can also move laterally with respect to the table 22 thus allowing both lateral movement between the gantry 20 and the table 22 and rotational movement of the x-ray sources 24 and their associated focused two-dimensional curved detector arrays 26 with respect to a patient, shown generally by the numeral 30, positioned on the table 22. Each two-dimensional curved detector array 26 is focused at the focal spot of its associated x-ray source 24. The focused two-dimensional curved detector arrays 26 can also image isotopes from positron emitters for PET imaging and single photon emitters for NM/SPECT imaging.

The imaging system 14 can perform anatomical x-ray volume computed tomography (VCT), digital radiography (DR), molecular imaging with positron emission tomography (PET) and nuclear medicine/single photon emission computed tomography (NM/SPECT). The VCT, DR, PET and NM/SPECT images can be collected in a static or dynamic state with respect to time for x-ray VCT static and dynamic morphological images of a patient's anatomy, and for static or dynamic images of a patient's molecular, physiological and biochemical functions. The resulting images and physiological monitoring data are transmitted to the multi-modality fused imaging, analysis, and computer aided diagnosis system 16.

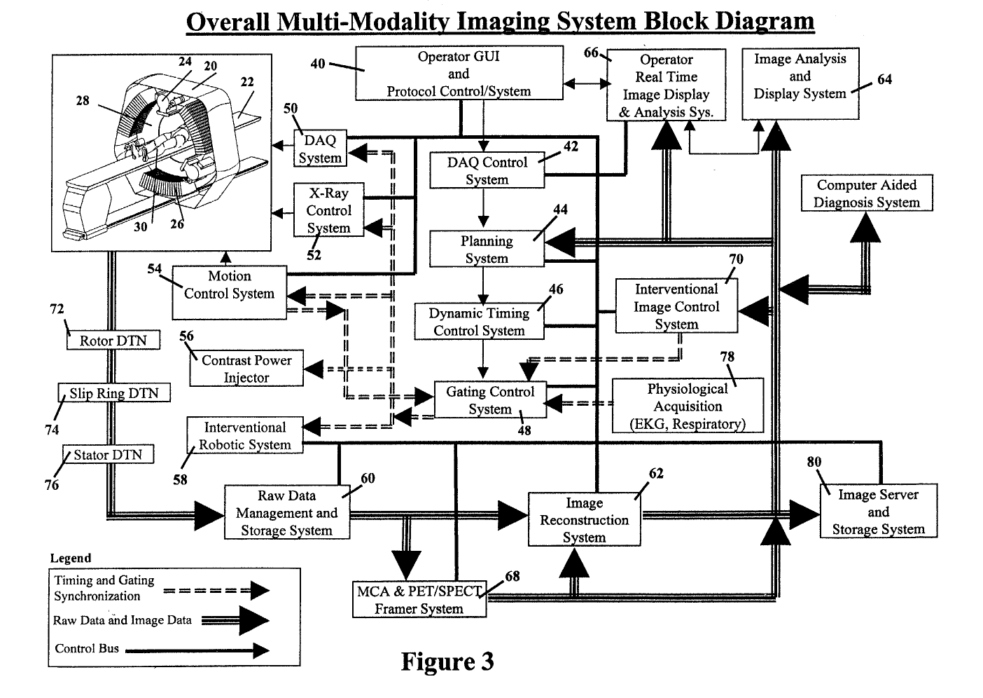

Referring now to FIG. 3, the overall multi-modality imaging system 14 and the multi-modality fused imaging, analysis, and computer aided diagnosis system 16 are shown in functional block diagram form. The gantry 20, table 22, x-ray sources 24, focused two-dimensional curved detector arrays 26, rotate plate 28 and the data acquisition system are controlled and monitored by several major systems during the multi-modality imaging process. The block diagrams show the major data paths for imaging data (raw data from a data acquisition system), image data, control data, and timing and gating control data.

The operator selects the clinical protocol to be used through an operator graphical user interface 40 to initiate the imaging or scanning process. The protocols are ordered, chained and interconnected together and the process of data acquisition is initiated. A data acquisition control system 42 transmits commands to a planning system 44 which acquires whole body projection images of the patient from several planar angles. These images include views such as anterior, posterior, right lateral, left lateral and oblique projection views. These images are used to perform dosage calculations and to establish interconnected data acquisition (DAQ) protocols, such as VCT, gated VCT, dynamic contrast injected VCT, whole body projection PET, PET, gated PET, whole body NM/SPECT, and gated NM/SPECT imaging protocols. These DAQ protocols are transmitted to a dynamic timing control system 46 that synchronizes timing events in the system and in external devices that support the system protocols to produce time-dependent clinical protocols, such as precise contrast injection, VCT angiography, flow studies, tri-phasic studies and synchronized EKG gating with contrast bolus injection. In addition, the timing control system 46 provides precise timing for event controlled procedures and interventional biopsy procedures.

The timing signals produced by the timing control system 46 are transmitted to a gating control system 48 which synchronizes the operation of a data acquisition (DAQ) system 50, an x-ray control system 52, a motion control system 54, a contrast power injector 56, an interventional robotic system 58, a raw data management and storage system 60, an image reconstruction system 62, and an image analysis and interactive display system 64. An operator real-time image display and analysis system 66 is interposed between the operator graphical user interface 40 and the image analysis and interactive display system 64. A multi-channel analyzer and PET/SPECT framer system 68 is interposed between the raw data management and storage system 60 and the image reconstruction system 62 and provides data to the image analysis and interactive display system 64. The gating control system 48 is a real-time event control system which accepts and commands control information to and from the motion control system 54 to control rotational movement of the rotate plate 28, transverse movement of the gantry 20, and transverse and vertical movement of the table 22 so as to synchronize rotation of the x-ray sources 24 and their associated focused two-dimensional curved detector arrays 26 with physiological signals, such as EKG, and to command the x-ray control system 52 and the data acquisition system 50 to sample data in coordination with motion, physiological gating and patient contrast flow parameters.

The motion control system 54 allows real-time coordinated motion of all drive systems and supplies real-time feedback of position information for synchronized data acquisition. The motion control system 54 accepts external inputs from the gating control system 48 and provides synchronization of rotational movement of the x-ray sources 24 and their associated focused two-dimensional curved detector arrays 26 and the traverse movements of the gantry 20 relative to the patient's heart rate and other physiological signals. The motion control system 54 also interfaces with the interventional robotic system 58 that supports semi-automatic procedures, such as needle biopsies and minimally invasive surgery.

The x-ray control system 52 causes the generation of x-rays at different energy and x-ray intensity levels from the x-ray sources 24 whose focal spots can be moved geometrically in synchronization with the gating control system 48. The x-ray control system 52 can be pulsed rapidly for cardiac gated imaging applications. The data acquisition system 50 controls the collection and sampling of signals from the focused two-dimensional curved detector arrays 26 and other physiological data. The data acquisition system 50 contains internal memories and signal processing capabilities for processes, such as VCT, gated VCT, spiral VCT, DR, whole body DR, whole body projection PET, PET, gated PET, whole body projection single photon imaging, NM/SPECT, and gated NM/SPECT imaging. Also, the data acquisition system 50 performs “on-the-fly” calibration corrections for each signal channel or pixel, geometric corrections, geometric image compaction, adaptive projection data feedback and continuous VCT imaging. The interventional robotic system 58 receives control information from an interventional image control system 70.

The raw data management and storage system 60 receives data from the data acquisition system 50 via a rotor data transfer network 72, a slip ring data transfer network 74, and a stator data transfer network 76. The slip ring data transfer network 74 can be a slip ring assembly, such as an optical slip ring. The raw data management and storage system 60 stores the data that it receives for the various processing modes in the image reconstruction system 62.

A physiological acquisition and gating control system 78 interfaces with physiological monitors, such as EKG, heart rate, respiratory rate, blood pressure, body temperature, EEG and brain wave monitors, and body motion geometry sensors to provide input to the gating control algorithms. The gating control system 48 uses any of these physiological signals to generate an average histogram to control the internal gating system.

The image reconstruction system 62 performs calibration corrections and produces images from the raw data that it receives. The reconstruction system 62 can construct cone beam volume computed tomography, spiral VCT, whole body projection PET, whole body projection SPECT, ordered subset expectation maximization (OSEM) PET, OSEM SPECT, DR, and other whole body images. In addition, the reconstruction system 62 can interactively generate three-dimensional planar reformatting of volume data, sagittal, coronal, transaxial, surface views and maximum intensity views in a near real-time interactive display review.

The interventional image control system 70 operates in conjunction with the multi-modality imaging system 14 to plan and perform minimally invasive surgical procedures. The multi-modality imaging system 14 has the capability of providing therapy and interventional needle placement through the interventional robotic system 58. Images generated by the multi-modality imaging system 14, including VCT, PET, and NM/SPECT images are used by the interventional image control system 70 to interactively establish and control interventional procedures in real-time with respect to robotic and manual motions.

The operator real-time image display and analysis system 66 is provided with direct synchronized connections to several major systems for the real-time updating of information to the monitors and controls utilized by the operator. The operator real-time image display and analysis system 66 provides real-time updates of information, such as, EKG, average EKG, respiratory motions, table positions, gantry position, rotation positions, images provided by the planning system 44, data provided by the dynamic timing control system 46, data provided by the gating control system 48, EKG view filling diagrams for prospective and retrospective gating controls, contrast injector status, x-ray system status, raw data transfer status, raw data storage status, energy collection windows for NM/SPECT and PET modes of operation, coincidence timing windows, randoms and delayed timing windows for PET, PET and NM/SPECT count rate monitors, histogram images for PET and NM/SPECT modes of operation, continuous VCT monitoring images, fluoroscopic DR monitor images, cine′ DR, VCT, PET, and NM/SPECT imaging displays, real-time multi-planar displays, interventional planning and comparison tracking monitors, and current reconstruction status for collected VCT, PET, and NM/SPECT raw data.

The operator real-time image display and analysis system 66 monitors contrast levels and performs real-time background subtraction for image control of contrast injection in tri-phasic VCT angiographic imaging. In the PET and NM/SPECT modes of operation, coincidence timing windows for the multi-channel analyzer 68, projection framing count levels, and scatter correction can be performed by the operator real-time image display and analysis system 66 to adaptively control the image acquisition rate and to provide input to the motion control system 54 for the next set of views. The interventional image control system 70 operates in conjunction with the operator real-time image display and analysis system 66 to implement image guided minimally invasive surgical procedures and interventional image guided therapy.

An image server and storage system 80 stores image data produced by the image reconstruction system 62 and the image analysis and interactive display system 64. The image analysis and interactive display system 64 displays data that have been reconstructed, generates reports, and fuses the multi-modality images and data. The multi-modality fused imaging, analysis and computer aided diagnosis system 16 takes data from the image analysis and interactive display system 64 and provides the best diagnosis and therapy for the patient.

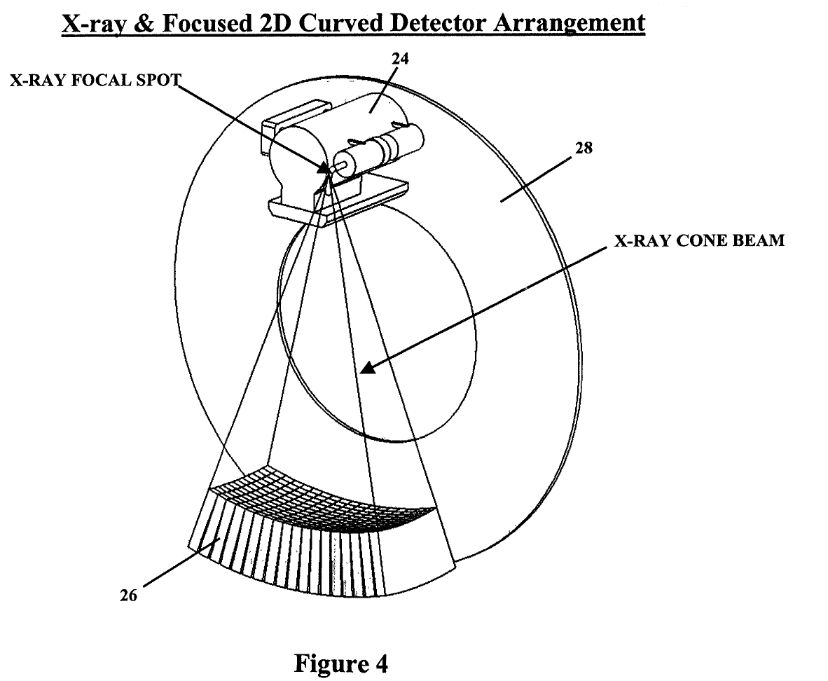

An x-ray source 24 and its associated focused two-dimensional curved detector array 26 attached to a rotate plate 28 are illustrated in FIG. 4. As illustrated in FIG. 2, three (3) x-ray sources 24 angularly spaced 120 degrees apart with each x-ray source 24 having an associated focused two-dimensional curved detector array 26 are attached to the rotate plate 28. Each x-ray source 24 produces x-rays in the form of a cone beam that is intercepted by its associated focused two-dimensional curved detector array 26.

The arrangement of an x-ray source 24 and its associated focused two-dimensional curved detector array 26 is referred to as an “imaging head”. As shown in FIG. 2, multiple imaging heads can be attached to the rotate plate 28. It has been found that three (3) imaging heads are preferred for optimal imaging speed versus the rotational speed of the rotate plate 28. The rotate plate 28 also provides precise optical alignment of the x-ray sources 24 with their associated focused two-dimensional curved detector arrays 26. As indicated, each x-ray source 24 is capable of generating cone beam x-ray radiation for transmission through the patient for collection by its associated focused two-dimensional curved detector array 26. The preferred x-ray anode has a V-groove design for larger Z-axis cone beam angles giving isotropic resolution. X-ray source collimation is provided at the output port of the x-ray tube 24 to collimate the x-ray radiation so as to cover the desired data acquisition area and to limit patient dosage to only the image volumes desired.

Each focused two-dimensional curved detector array 26 incorporates x-ray anti-scatter collimation and focused pixel alignment toward the focal spot of its associated x-ray source 24. The radius of curvature of each focused two-dimensional curved detector array 26 is equal to the distance between the detector array 26 and the focal spot of its associated x-ray source 24. The focused two-dimensional curved detector array 26 can also perform PET coincidence imaging when at least two detector systems are utilized. NM/SPECT imaging can also be performed with the detector system. The focused two-dimensional curved detector arrays 26 include down conversion materials, photo converters, signal processors, and digital converters for each pixel. Down conversion materials convert x-ray or gamma ray photons to lower frequencies or directly into electron flow.

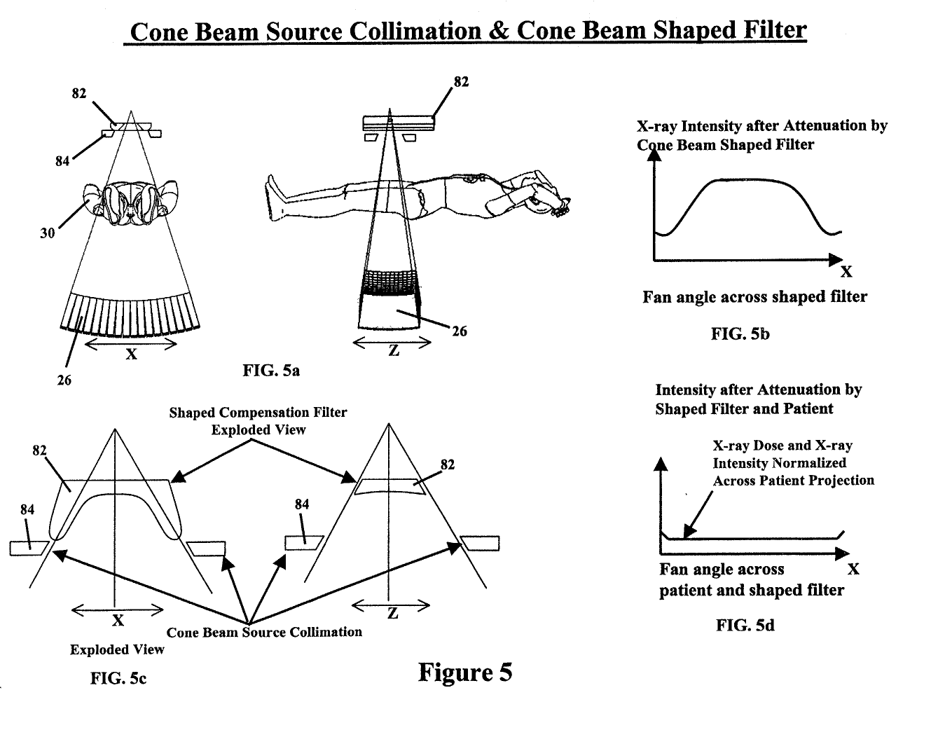

Referring now to FIG. 5a, a cone beam shaped compensation filter 82 and a source collimator 84 for an x-ray source is illustrated. The collimated x-ray signal is projected onto its associated focused two-dimensional curved detector array 26. The size of the x-ray “collection” area may vary from full cone beam for whole body projections to head size scan volumes. The size of the x-ray “collection” area can also be reduced for partial area reconstruction, such as spine, cardiac, or inner auditory canal imaging. The overall width, or fan width, of the cone beam x-ray radiation is optimized based upon clinical protocol. Also, the Z-axis may be varied over a Z-axis range from full Z-axis field of view to single slice field of views. The collimation of the cone beam radiation can be programmed to change dimensions in both the X-axis and Z-axis directions.

The cone beam shaped compensation filter 82 reduces skin dosage during VCT imaging. The shape of the compensation filter 82 across the patient is approximately the inverse of the nominal patient shape. Therefore, the cone beam shaped compensation filter 82 has a shape similar to a parabola. As shown in FIG. 5b, the x-ray intensities are attenuated toward the edges of the scan circle and full x-ray intensity is applied to the center of the scan circle. Larger flux levels in the center of the scan circle are required because the greatest patient attenuation occurs in this region.

As shown in FIG. 5c and FIG. 5d, the use of the cone beam shaped compensation filter 82 causes the dynamic range provided by the focused two-dimensional curved detector array 26 to be reduced while central x-ray flux is preserved when a patient is in the scan circle. The Z-axis shape of the cone beam compensation filter 82 varies minimally as compared to the x-axis since the patient is viewed as an ellipsoid cylinder. The compensation filter 82 reduces scattered x-ray radiation into the central ray of the cone beam since scattered x-rays are attenuated by the compensation filter 82 on the scan circle edges.

The beam energy or exit spectrum varies as a function of the fan angle across the cone beam x-ray radiation, as shown in FIG. 5b. The compensation filter 82 has corresponding calibrations to correct for variations in x-ray intensity and x-ray energy through a patient. The corrections provided by the compensation filter 82 are based upon patient size and water equivalent x-ray energy spectrum imaging.

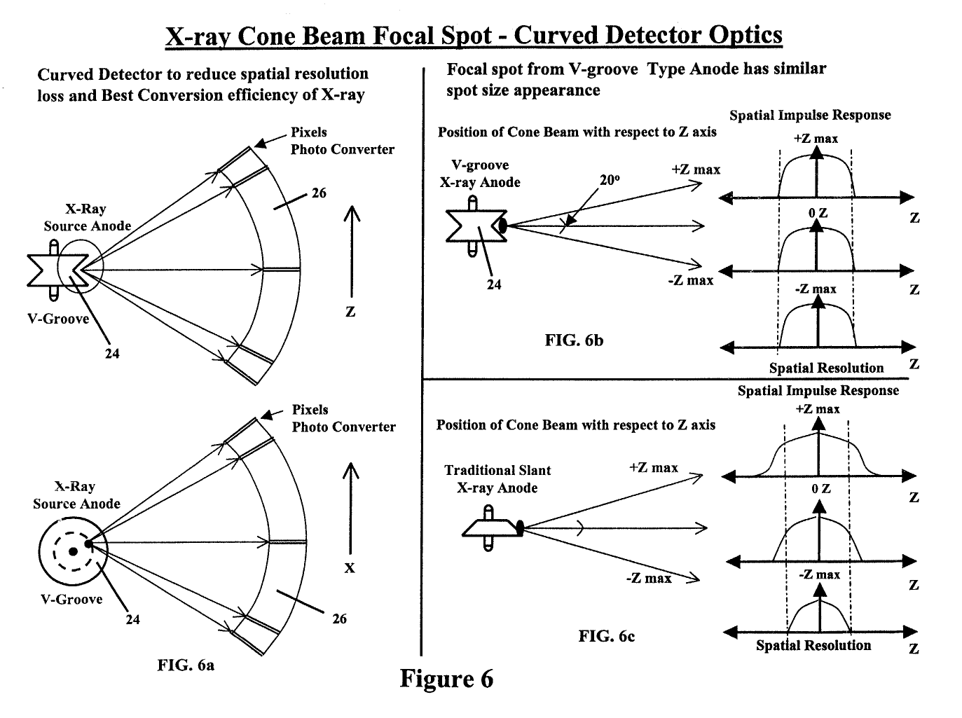

Referring now to FIG. 6a, the focal spot of an x-ray source 24 and its associated focused two-dimensional curved detector array 26 is illustrated. With the vertex of the focused two-dimensional curved detector array 26 directed toward the x-ray focal spot, the x-rays penetrate the pixels within the detector array 26 in a normal perpendicular orientation to achieve maximum conversion efficiency of the x-ray photons. This focusing arrangement permits the detector photo-converter materials to absorb radiation with minimal cross-talk between adjacent channels or pixels. The foregoing applies to both directions of the cone beam x-ray radiation and detected by the focused two-dimensional curved detector array 26.

In FIG. 6b, the Z-axis view of the x-ray optical geometry is illustrated along with comparisons of a V-groove type x-ray anode versus a slanted type x-ray anode. An important benefit of the V-groove type anode design, along with the use of an associated focused two-dimensional curved detector array 26, is that the spatial resolution in the Z-axis direction does not decrease significantly, as compared to a slanted-type x-ray anode design. The plots shown in FIG. 6b and FIG. 6c are spatial impulse plots which illustrate change in the impulse width as a function of Z-axis fan angle. To illustrate the foregoing, the system resolution response functions for three angles, i.e., +Z maximum, 0, and −Z maximum rays, are shown in FIG. 6b and FIG. 6c. For comparison purposes, it should be noted that the resolution of the slanted type x-ray anode design varies based upon Z-axis position, as illustrated in FIG. 6c. In the V-groove type anode design, the +Z maximum, 0, and −Z maximum rays have similar spatial resolution responses, as shown in FIG. 6b.

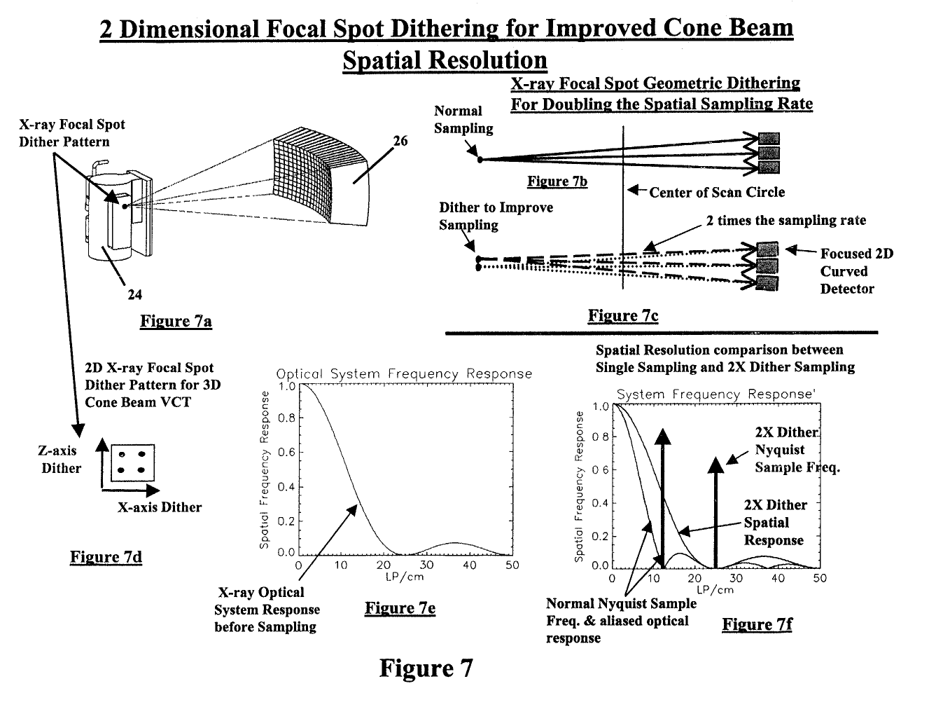

FIG. 7 illustrates two-dimensional focal spot dithering for improved cone beam spatial resolution. In this case, the sampling frequency can be increased by geometrically dithering the x-ray focal spot in two dimensions. The focused two-dimensional curved detector arrays 26 and their associated x-ray sources 24 attached to a rotate plate 28 revolve around the patient 30. The spatial sampling is limited by the number of pixels in two dimensions of the detector array 26, as shown in FIG. 7b. The spatial frequency response of the x-ray optical system is illustrated in FIG. 7e. To resolve the x-ray optical response, the sampling rate must be greater than 50 line pair per centimeter (lp/cm), as shown in FIG. 7f for a Nyquist sampling rate or Nyquist frequency of 25 lp/cm. The Nyquist sampling rate for the system without dithering is 12.5 lp/cm. The x-ray optical information that is greater than 12.5 lp/cm is aliased back into the 0 to 12.5 lp/cm Modulation Transfer Function (MTF) region. Band limiting of the system sampling reduces this effect but also affects the MTF region. The approximated aliased response is shown in FIG. 7f with a maximum frequency of 12.5 lp/cm.

As shown in FIG. 7b, the sampling rate at the center of the scan circle is 12.5 lp/cm. The sampling frequency can be doubled in two dimensions by geometrically shifting or dithering the x-ray focal spot or the detector in two dimensions. The magnitude of the shift corresponds to about one-half the detector pitch of the focused two-dimensional curved detector array 26, shown in FIG. 7c. This shift produces a one-fourth detector pitch at the center. With x-ray focal spot or detector dithering, the Nyquist sampling is increased by a factor of 2 to 25 lp/cm effectively doubling the system resolution, as shown in FIG. 7f. The dithered x-ray focal spot is shifted synchronously with respect to the VCT data acquisition process. As shown in FIG. 7d, the x-ray focal spot is rapidly shifted or dithered two dimensionally for each angular view so that a virtual detector has four times the number of pixels, i.e., double sampling will exist in both dimensions of the detector. The focused two-dimensional curved detector array 26 may also be mechanically dithered in the X and Z directions to produce a similar double sampling effect for improved spatial resolution. The shift of one-half of the pixel pitch results in doubling the Nyquist sampling rate.

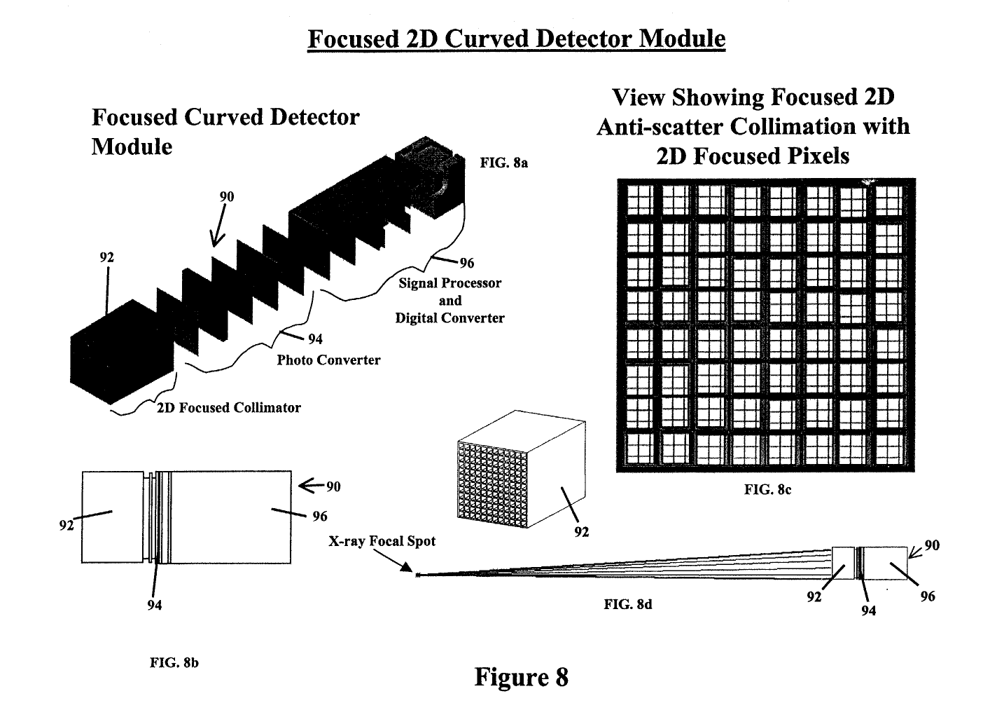

FIGS. 8a and 8b illustrate an embodiment of a focused two-dimensional curved detector module 90 which can be used to build a focused two-dimensional curved detector array 26. Each module 90 is designed to mate with other modules 90 to achieve good geometric collection efficiency and to reject scattered x-ray radiation by utilizing a focused two-dimensional anti-scatter collimator 92 that is attached to a photo converter 94 which may be a scintillation crystal in combination with a photodiode or a photo-sensitive micro-channel plate array. The signal processing section 96 of the focused two-dimensional curved detector module 90 allows x-ray integration and pulse processing for PET and NM/SPECT processing on an individual channel basis. Each pixel or channel may be processed independently resulting in very high-count rate PET and NM/SPECT imaging. The detector elements are thermally stabilized to allow for high dynamic range operation for x-ray VCT and DR modes of operation.

In the pulse counting mode of operation for PET and NM/SPECT, the channel signal processing within the detector module 90 is changed to operate asynchronously with channel event triggering. Within the focused two-dimensional anti-scatter collimator 92, multiple pixels are focused on the x-ray source to obtain the best spatial resolution and provide reasonable dose efficiency while rejecting scattered x-ray radiation. The number of pixels within a collimator 92 may vary, such as 2×2, 4×4 or 8×8. FIG. 8c depicts one such embodiment of anti-scatter collimation as viewed from the x-ray source 24. FIG. 8d represents a side view of the focused anti-scatter collimation.

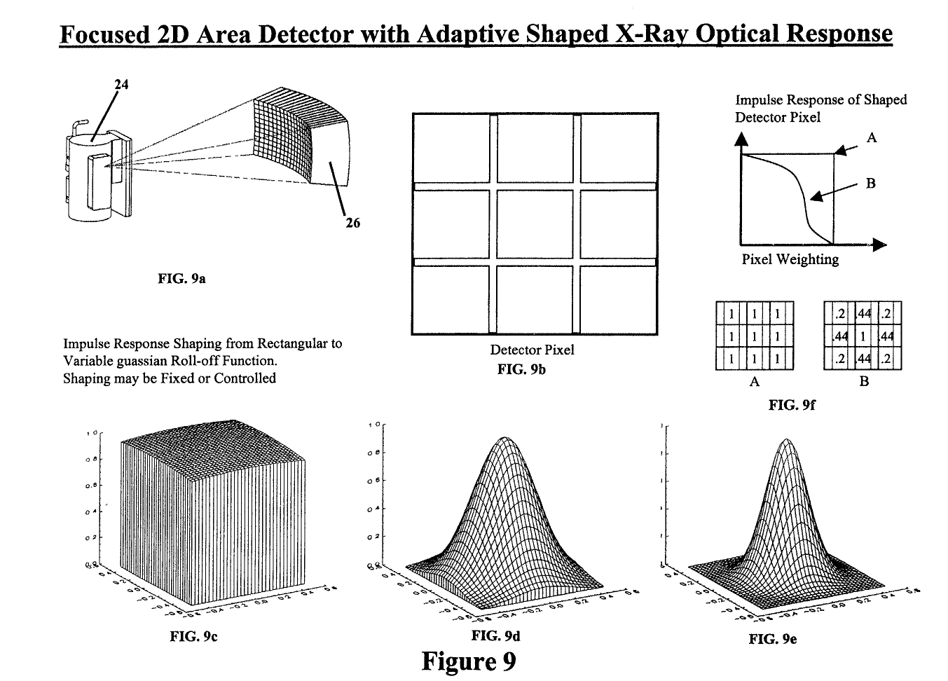

FIG. 9a illustrates an x-ray source 24 and its associated focused two-dimensional area detector array 26 and shows an adaptive shaped x-ray optical response for same by adjusting the spatial resolution response function. The foregoing is accomplished by subdividing the pixel into sub-pixels. As illustrated in FIG. 9b, the pixel is subdivided into nine sub-pixels. Each sub-pixel can be integrated with its neighboring sub-pixels through weighting coefficients to change the effective x-ray optical response of the system. The x-ray optical response of the system may be adjusted, as illustrated in FIGS. 9c, 9d and 9e, from a rectangular response to a shaped response having a higher resolution. The weight matrices, illustrated in FIG. 9f, allow the two-dimensional x-ray optical response to be altered. The changing of the weighting coefficients can be accomplished adaptively based upon spatial and contrast resolution characteristics desired for patient imaging.

The shaping of the response of the sub-pixel can be accomplished as part of the summation by the photo converter 94 before pixel integration. Also, the shaped response function can be achieved by optical weighting of sub-pixels to obtain the desired response. The advantage of shaped response pixels is that the x-ray optical response can be changed by adjusting the weighting coefficients electronically or optically. When pixels have a lower x-ray spatial resolution response, improved contrast resolution is achieved. The response function of the focused two-dimensional curved detector array 26 is adjusted based upon patient anatomy and clinical imaging protocol.

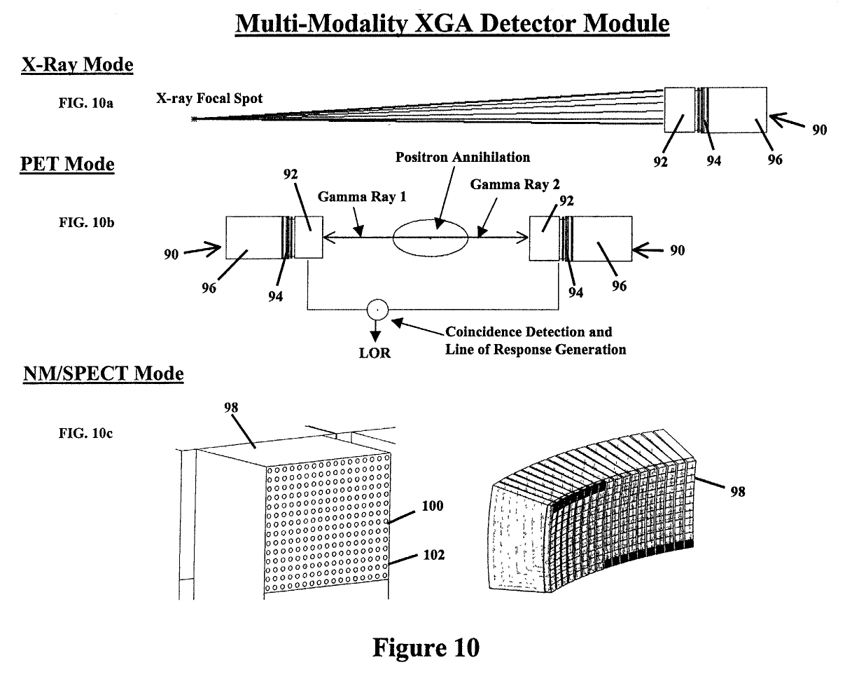

FIG. 10 illustrates that the focused two-dimensional curved detector module 90 can be operated in the x-ray mode, the PET mode or the NM/SPECT mode. In the x-ray mode of operation, as shown in FIG. 10a, x-rays are collected by the direct line of sight radiation from the focal spot of the x-ray source 24 to the detector channel pixel. Anti-scatter collimation reduces Compton scattered x-ray radiation for angles not in direct alignment with the x-ray focal spot to detector pixel arrangement. Three-dimensional cone beam imaging systems incorporate anti-scatter collimation to obtain comparable contrast ratios in clinical patient VCT imaging. The focused two-dimensional curved detector design is an optimal requirement for VCT imaging.

In the PET mode of operation, as shown in FIG. 10b, the 511 Kev gamma rays resulting from positron annihilation are 180 degrees opposed to one another and separate detector arrays are utilized to detect the gamma rays. In the detection process, the time for each gamma ray is recorded and a common coincidence timing comparison is executed to sort out those events that are associated with one another permitting the generation of a line of response (LOR). The line of response (LOR) contains information as to the time of the coincident event and the three-dimensional description of the line traced out by two 511 Kev gamma rays. The foregoing is referred to by those skilled in the art as electronic collimation.

In the NM/SPECT mode of operation, as shown in FIG. 10c, additional collimation is provided by the use of a collimator 98 comprised of septa 100 and holes 102 and is referred to as mechanical collimation. In the NM/SPECT mode of operation, gamma collimation and the anti-scatter collimation on the detector perform very similar functions. The NM/SPECT collimators 98 for the focused two-dimensional curved detector arrays 26 provide additional collimation to the collimation provided by the anti-scatter collimator 92 within the detector module 90.

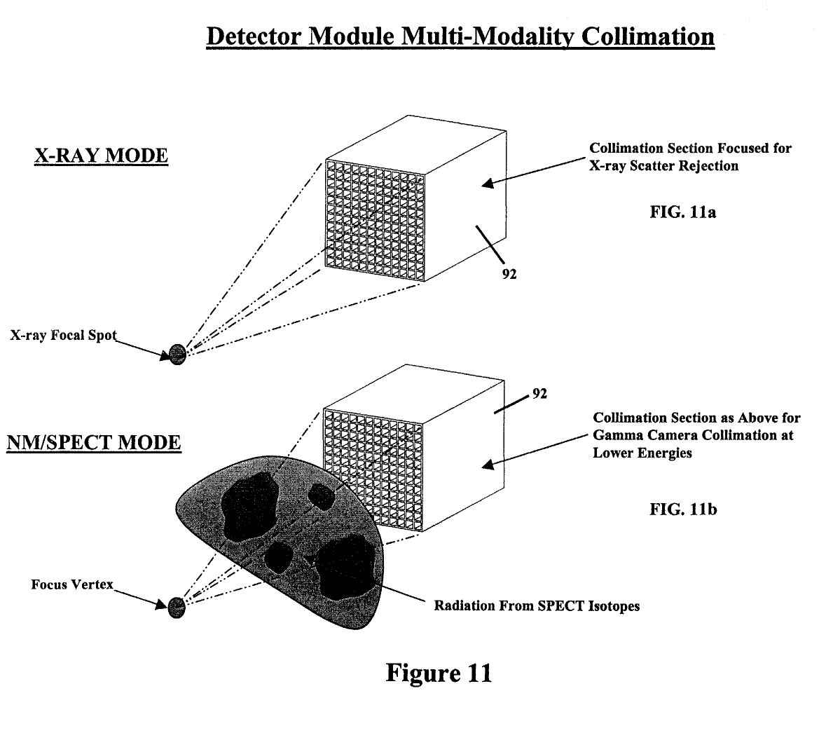

The focused two-dimensional anti-scatter collimator 92 within the detector module 90 is used for both the x-ray mode of operation, as shown in FIG. 11a, and the NM/SPECT mode of operation, as shown in FIG. 11b. In the x-ray mode of operation, the collimator 92 is used for scattered x-ray radiation rejection whereas in the NM/SPECT mode of operation, the collimator 92 is utilized for gamma camera collimation at lower energies. The radiation illustrated in FIG. 11b is produced by the isotopes within the patient's body. In the NM/SPECT mode of operation, gamma camera collimation and the anti-scatter collimation provided by the detector module 90 perform very similar functions and are additive in nature.

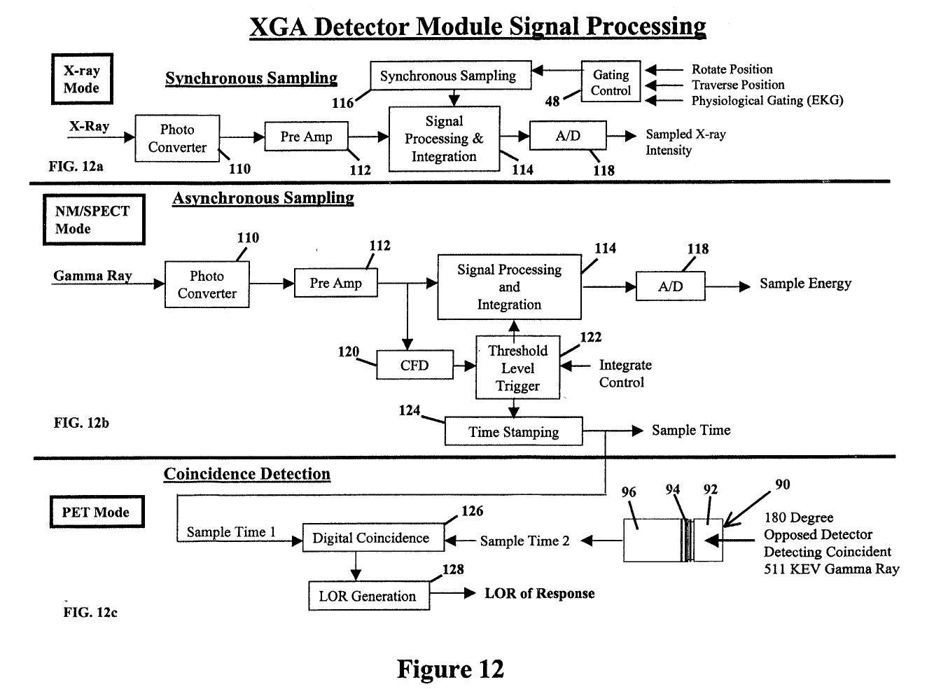

Block diagrams illustrating the functional apparatus required for processing x-rays and gamma rays are shown in FIG. 12. The detector module 90 has three modes of operation, i.e., x-ray integration mode with synchronous sampling, NM/SPECT mode with asynchronous sampling, and PET mode with asynchronous sampling, coincidence detection and LOR generation. The processing is known as x-ray, gamma ray, area (XGA) detector module signal processing

Referring now to FIG. 12a, the manner in which an x-ray is detected and processed utilizing synchronous sampling controls is shown. In this case, x-ray photons are detected by a photo converter 110 which may be constructed from a scintillation crystal or a direct conversion material, such as cadmium zinc telluride (CZT). In addition to the scintillation crystal, the photo converter 110 may include a photo diode, an avalanche photo diode, or a multi-anode micro-channel plate amplifier. The photo converter 110 converts the x-ray photons into electrons. The electrons are then amplified by a pre-amplifier 112 having a sufficient gain and high signal to noise ratio to provide at least a one million to one dynamic range at a controlled gain setting. The bandwidth of the pre-amplifier 112 is adjusted to correspond closely with the sampling rate in order to obtain a high signal to noise ratio. The output of the pre-amplifier 112 is applied to a signal processor and integrator 114 whose operation is controlled by a synchronous sampling device 116. The output of the signal processor and integrator 114 is applied as an input to an analog to digital converter 118. The form of conversion may be analog to digital, current to digital, voltage controlled oscillator (VCO) to digital, etc. The analog to digital converter 118 produces a sampled signal proportional to the input x-ray flux level and the energy of the x-ray flux. In the x-ray mode of operation, total x-ray photons per unit of time are summed over all detectable photon energies. The synchronous sampling of the signal processor and integrator 114 by the synchronous sampling device 116 and the subsequent analog to digital conversion of the resulting sampled signal are controlled by the gating control system 48 into which gantry position parameters and physiological gating signals are inputted. For x-ray VCT and DR, all channels are sampled in a synchronous manner over the entire focused two-dimensional curved detector array 26. The projected x-ray two-dimensional images are sampled concurrently for all pixels. The projected images are then utilized for DR presentations or are reconstructed by the image reconstruction system 62 to generate VCT images.

FIG. 12b illustrates the NM/SPECT mode of operation. In this mode of operation and in the PET mode of operation, the detector module 90 counts photons and determines the energy of the detected gamma rays and the position of these rays. In these modes of operation, each channel has independent sampling and processing capabilities, and asynchronous sampling of the channels is utilized. Each channel has the capability to trigger and integrate. The analog to digital conversion cycle is independent of adjacent channels permitting very high-count rate capabilities for the detector module 90. As in the case of the x-ray photons, the gamma rays interact with the photo converter material to produce electrons and the number of electrons generated is proportional to the energy of the gamma ray. During the photo conversion process, the photo converter 110 converts gamma ray photons into electrons. The signal produced by the photo converter 110 is applied to the pre-amplifier 112. The photo converter 110 and the pre-amplifier 112 provide sufficient gain with a high signal to noise ratio in order to integrate the number of electrons generated by the gamma rays. The electron pulse generated by the gamma rays is transmitted to both the signal processor and integrator 114 and to a constant fraction discriminator (CFD) 120 to give amplitude independent timing. The output of the constant fraction discriminator 120 is transmitted to a threshold level trigger circuit 122 having zero crossing detection capabilities. An output of the threshold level trigger circuit 122 is applied as an input to the signal processor and integrator 114. The threshold is controlled externally permitting selection of energies for asynchronous triggering. When a trigger signal is generated, the integrate and digital conversion cycles are initiated for the respective channel. The output of the signal processor and integrator 114 is a signal that is directly proportional to the energy of the pulse. This signal is transmitted to the analog to digital converter 118 whose output is transmitted to the multi-channel analyzer 68 (not shown) for histogramming and framing purposes.

In the PET mode of operation, as illustrated in FIG. 12c, the output of the threshold level trigger circuit 122 is also transmitted to a time stamping device 124 to record the time of the event from the respective channel. The time is transmitted to a digital coincidence comparator 126 which compares times of independent events and sorts out those events that can be matched up so that a line of response (LOR) can be generated. The line of response generation takes the position of each coincident event and generates the line of response (LOR) 128. The line of response (LOR) 128 provides time, energy, angles and position for histogramming and LOR framing by the multi-channel analyzer 68 (not shown).

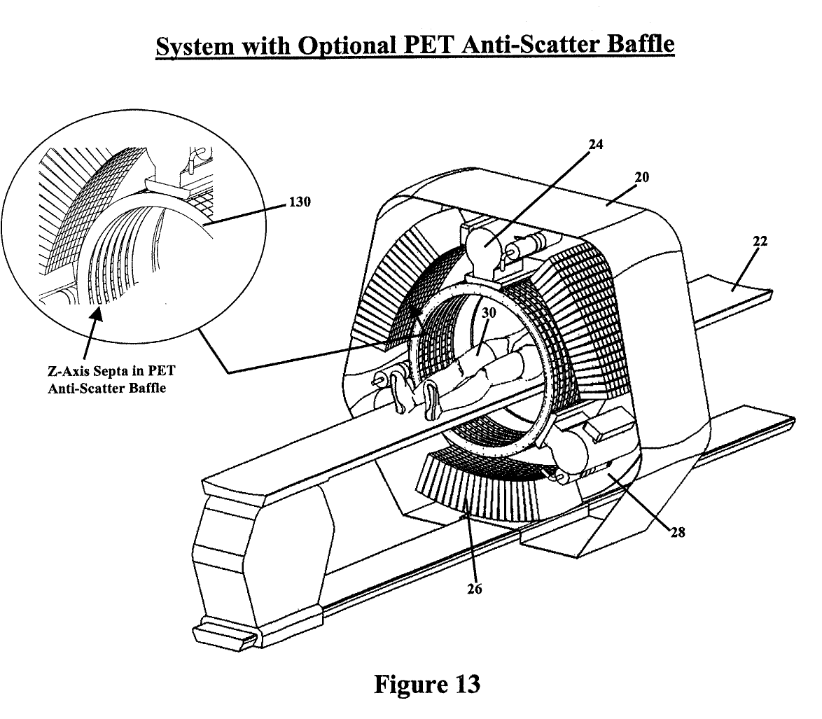

Referring now to FIG. 13, the multi-modality imaging system 14 is illustrated in the PET mode of operation. The system shown in this Figure includes an optional anti-scatter baffle 130 that is interposed between the patient 30 and the x-ray sources 24 and their associated focused two-dimensional curved detector arrays 26. The baffle 130 is adjustable to reduce gamma ray scattered radiation that is out of the field of view. The baffle 130 limits the field of view for three-dimensional PET imaging. The anti-scatter baffle 130 reduces the scatter fraction radiation and radiation that is out of the field of view while preserving true coincidence counting rates.

The anti-scatter baffle 130 is comprised of a ring of Z-axis septa and is readily insertable into the imaging field of view to allow VCT and PET imaging with minimal patient motion or discomfort. The septa width of the anti-scatter baffle 130 can be adjusted to allow three-dimensional field of view for optimal true coincidence count rate to gamma ray scatter radiation. During the PET mode of operation, the rotate plate 28 with the focused two-dimensional curved detector arrays 26 attached thereto is rotated slowly to normalize the three-dimensional uniformity of the resulting images.

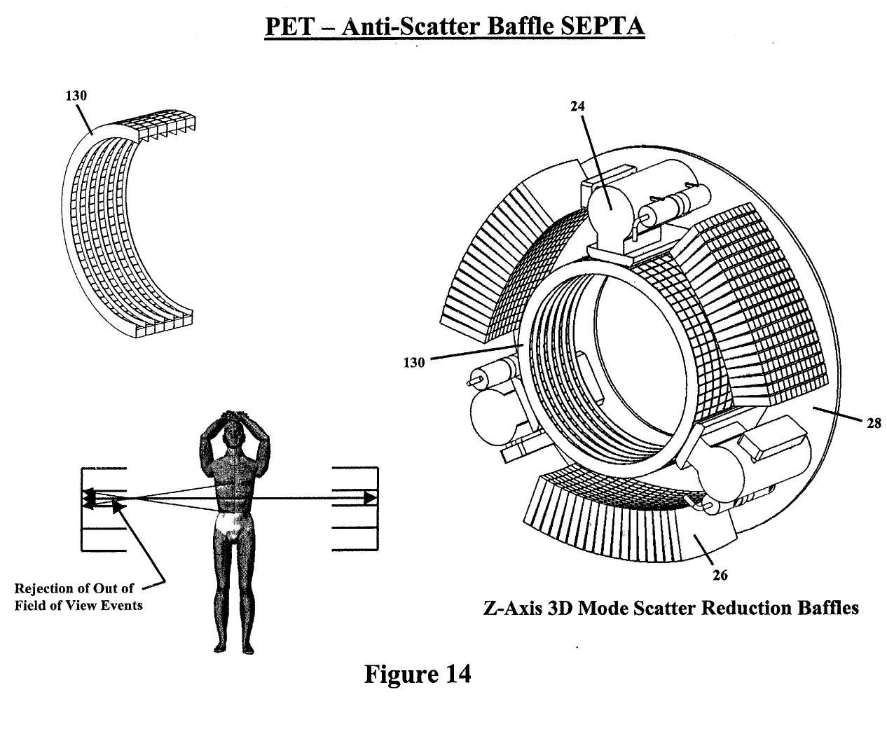

FIG. 14 illustrates placement of the PET anti-scatter baffle 130 with respect to the x-ray sources 24, the focused two-dimensional curved detector arrays 26 and the rotate plate 28. The PET anti-scatter baffle 130 is adjustable to reduce gamma ray scattered radiation that is out of the field of view. The anti-scatter baffle 130 and septa allow two-dimensional or limited field of view three-dimensional PET imaging. The design of the anti-scatter baffle 130 reduces the scatter fraction radiation and out-of-field of view radiation while preserving true coincidence counting rates. The anti-scatter baffle 130 can be rapidly moved into and out of the imaging field of view to allow VCT imaging and then PET imaging with minimal patient motion or discomfort. The width of the anti-scatter baffle septa can be adjusted to allow a three-dimensional field of view for optimized ratio of true coincidence count rate to gamma ray scatter radiation. During the PET mode of operation, the rotate plate 28 with the focused two-dimensional curved detector arrays 26 attached thereto is rotated slowly to normalize the three-dimensional uniformity of the resulting images.

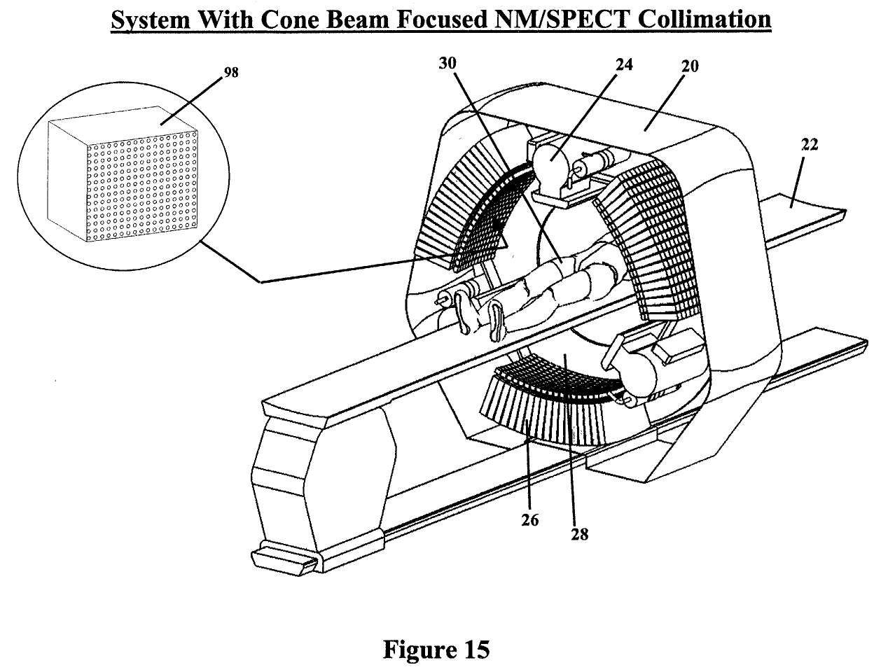

FIG. 15 illustrates the system 14 when in the NM/SPECT mode of operation. In this mode of operation, the cone beam focused NM/SPECT collimators 98 focus and collimate the NM/SPECT isotope radiation from the patient into the focused two-dimensional curved detector arrays 26. Different isotope energy resolution, spatial resolution and collimation sensitivity can be implemented by the cone beam focused NM/SPECT collimators 98. For low energy, high resolution (LEHR) collimation, the cone beam focused NM/SPECT collimators 98 can be used for most of the low energy nuclear isotopes.

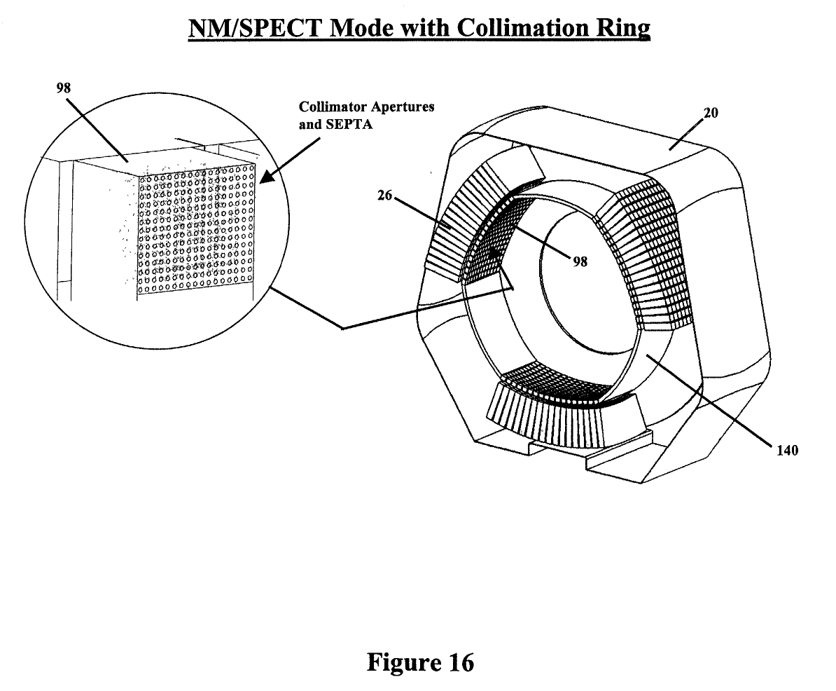

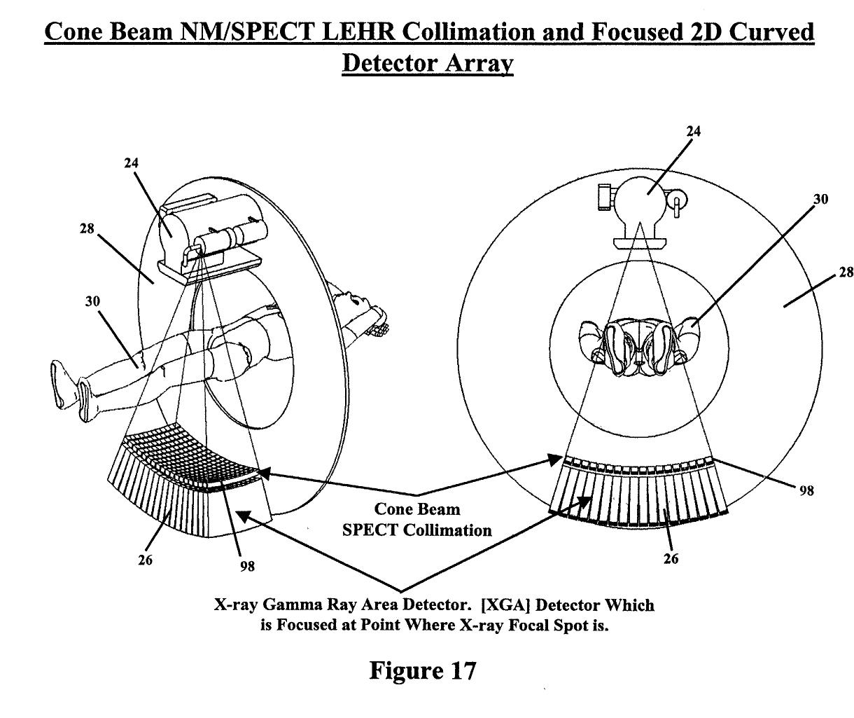

FIG. 16 illustrates a cone beam focused NM/SPECT collimation ring assembly 140 having a plurality of cone beam focused NM/SPECT collimators 98 inserted therein. The collimation ring assembly 140 provides optical alignment of the collimators 98 with the focused two-dimensional curved detector arrays 26. The cone beam focused NM/SPECT collimation ring assembly 140 can be inserted into the imaging field of view quickly to allow VCT imaging and then NM/SPECT imaging with minimal patient motion or discomfort. The NM/SPECT collimators 98 have the same focus point as the focused two-dimensional curved detector arrays 26. During the NM/SPECT mode of operation, the NM/SPECT collimators 98 and the focused two-dimensional curved detector arrays 26 are rotated slowly with respect to the patient for complete angle coverage of the patient. The imaging data are reconstructed with cone beam NM/SPECT algorithms. The collimation ring assembly 140 can be moved out of the detector imaging field for VCT and PET image acquisitions while the patient is lying on the table so as to preserve geometric registration. FIG. 17 illustrates the focus point for the cone beam NM/SPECT low energy, high resolution (LEHR) collimators 98 and the focused two-dimensional curved detector array 26. The focus point can be the same as the x-ray focal spot.

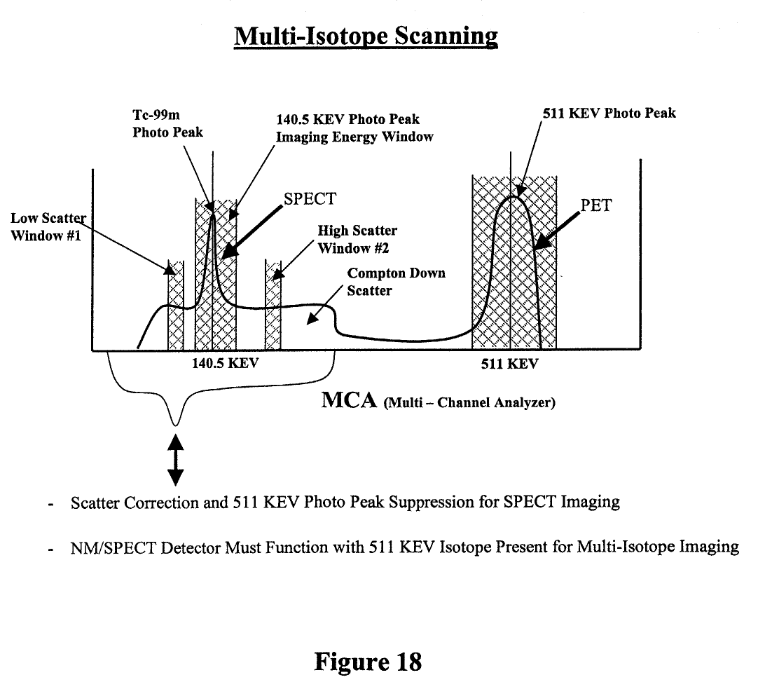

FIG. 18 illustrates the spectrum of the multi-channel analyzer 68 for both the SPECT Tc-99m isotope and the PET FDG-F18 isotope when performing multi-isotope scanning. The imaging photo-peaks for Tc-99m occur at 140.5 Kev and for FDG-F18 at 511 Kev. The imaging system 14, when in the NM/SPECT mode of operation, utilizes a scatter correction method that incorporates multi-energy windows around desired photo-peaks to produce “on-the-fly” scatter corrections. Also, VCT anatomical data are used as part of the scatter correction method.

When a patient has ingested multiple isotopes, such as Tc-99m for bone imaging and FDG-F18 for oncological imaging, each of the isotopes produces Compton down scattering which interferes with the imaging of the four dimensional distribution (x, y, z, t) of the other isotope. The Compton scattering functions of the isotopes interact with one another. With the FDG-F18 isotope, the photo-peaks are around 511 Kev and down scattering occurs into the 140.5 Kev photo-peak area of the Tc-99m isotope. To reduce the effects of such scatter radiation, energy windows are established around the photo-peak area of the desired isotope. The width of the energy window is approximately ±10% of the photo-peak, but better images result from smaller energy windows. Such smaller energy windows, however, require better system energy resolution. Scatter correction methods reduce the effects of the scatter events into the energy windows. The Compton scatter information is “patient dependent” based upon the patient's anatomical structure and the distribution of the isotopes within the patient's body. The multi-modality imaging system 14 utilizes VCT anatomical attenuation data and Compton down scatter measurements to adaptively adjust for undesired scattered functions. Iterative methods, such as ordered subset expectation maximization (OSEM) with prior VCT information, are used to correct for the Compton scattering and to provide more accurate respective isotope distribution for quantitative functional analysis.

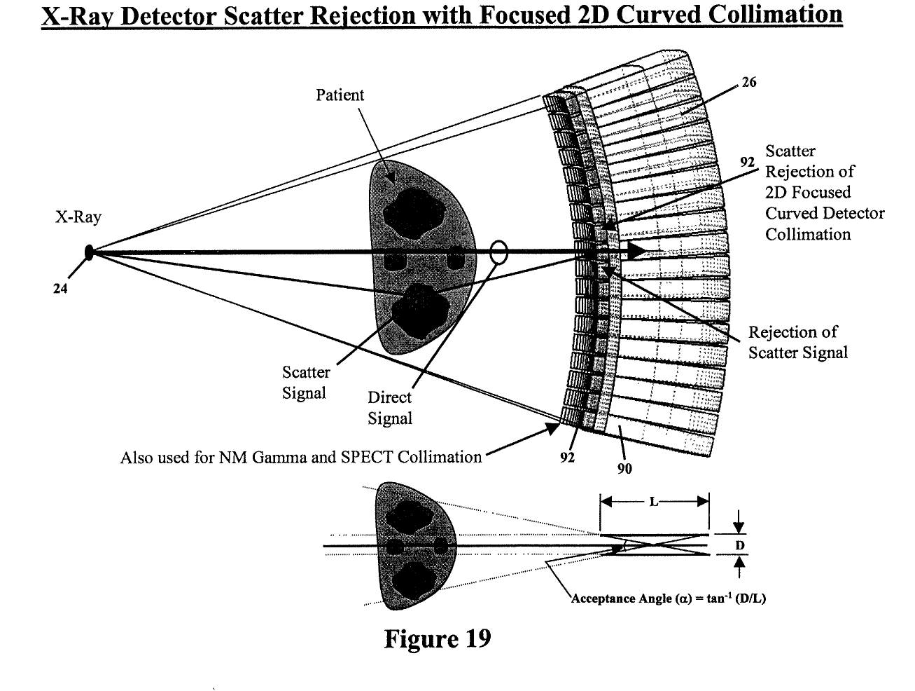

FIG. 19 illustrates x-ray detector scatter rejection with focused two-dimensional curved collimation. X-rays are generated at the focal spot of the x-ray sources 24 and are transmitted through the patient. The focused two-dimensional curved detector arrays 26 detect the x-ray radiation. As shown, the x-rays are generated in an x-ray cone beam format and are scattered within the patient's body via Compton scattering. Some of the x-rays are directed back to the same channel as the direct x-ray signal. Without the presence of focused collimation, the scatter x-ray signals would be added back to the direct x-ray signals, i.e., Iₜₒₜₐₗ=I_{direct}+I_{scatter}. The scattered x-ray signals are undesirable and change as the function of the scanning rotational angle. The focused two-dimensional anti-scatter collimator 92 filters and/or rejects scatter x-ray radiation. The effects of scattered x-ray radiation are usually more severe for three-dimensional cone beam geometries. The scattered x-ray radiation reduces contrast resolution and adversely affects the lower end of the dynamic range. In high attenuation areas of the body, the scattered x-ray signals can corrupt the direct x-ray signals in an additive fashion and reduce the ability to detect lower level x-ray signals. The collimator 92 is aligned with the vertex of the cone beam. Any misalignment of the focusing effect of the collimator septa causes pixel shading and possibly introduces artifacts, such as rings, into the VCT image. To reduce this effect, precise geometric mechanical alignment is required along with software calibrations and corrections during the three-dimensional cone beam image reconstruction process.

The septa for the collimator 92 is produced from a high Z material, such as tungsten or lead, to accomplish maximum attenuation of scattered x-ray signals with minimum septa thickness. Septa thickness and septa attenuation are “traded-off” with geometric dose efficiency of the focused two-dimensional curved detector array 26. The septa holes may contain several pixels or channels. The foregoing is an effective solution to the problem of geometric dose efficiency versus the number of septa. The scattered x-ray signals may be 10% to 20% of the direct x-ray signals. The scattered x-ray signals typically have a lower frequency than the direct x-ray signals and change from view to view. Having the septa and holes relatively large provides an effective rejection of the lower frequency scattered x-ray signals.

The length of the focused two-dimensional anti-scatter collimator 92 also affects the acceptance angle for direct x-ray signals versus the rejection of the scattered x-ray signals. This is referred to by those skilled in the art as the L to D ratio where L is the length of the collimator and D is the aperture size. As the length of the collimator 92 becomes larger with respect to its aperture size, the solid acceptance angle decreases in accordance with the following formula:

Acceptance Angle=Tan⁻¹(D/L)

In the multi-modality version with a common multi-mode focused two-dimensional curved detector array 26, anti-scatter collimation also serves as a NM/SPECT cone beam collimator for low energies. The resolution of the cone beam varies as the distance from the detector array.

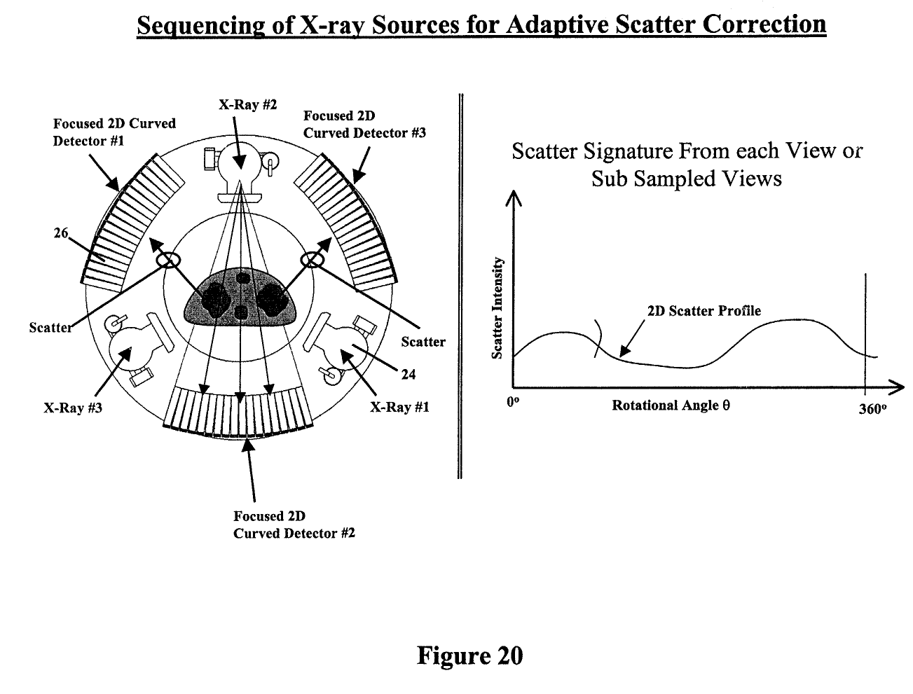

FIG. 20 illustrates a configuration of the multi-modality imaging system 14 utilizing three (3) imaging heads, i.e., three (3) x-ray sources 24 and three (3) associated focused two-dimensional curved detector arrays 26. The use of three (3) imaging heads improves temporal resolution and the signal to noise ratio for cine′ VCT imaging. With three (3) imaging heads, three times the imaging speed can be achieved for gated imaging clinical procedures. When using three (3) imaging heads to collect data, cross-Compton scattered x-ray radiation occurring between the imaging heads must be considered. An apparatus to reduce or correct for scattered x-ray radiation between imaging heads involves the sequencing of the x-ray sources 24 and the data acquisition by the detectors. A method for accomplishing the foregoing involves turning on only one x-ray source 24 and its associated focused two-dimensional curved detector array 26 so as to collect patient data while the other two (2) imaging detectors are turned on to collect Compton scattered x-ray radiation being emitted from the patient. The x-ray sources 24 are pulsed and the imaging heads are cycled to obtain a good estimate of the scattered x-ray radiation. These scatter views are utilized to develop a scatter signal over the entire VCT data collection process. The scatter signals are used to adaptively correct patient data that includes both true patient intensity data and scattered radiation intensity data. During the normal scanning process while collecting imaging data, the above described sequencing process is performed and produces a subset of views to determine the adaptive correction scatter signal. An ordered subset of views is selected to determine the scatter signal based upon images from the planning system 44.

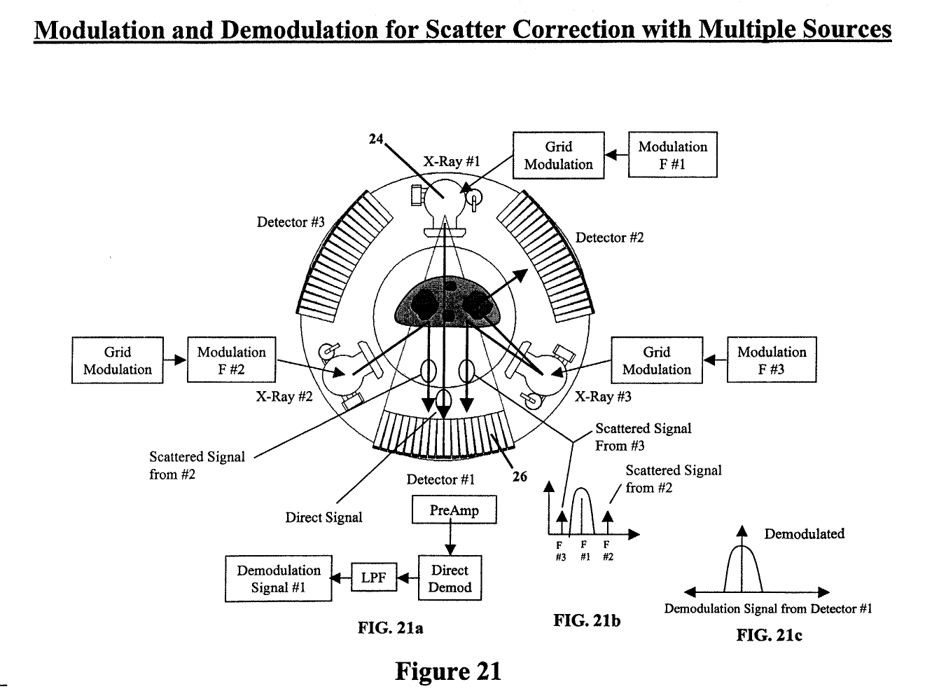

FIG. 21a illustrates an alternate method for dealing with scattered x-ray radiation through the use of intensity modulation and demodulation of the x-ray sources 24 and their associated focused two-dimensional curved detector arrays 26. Intensity modulation and demodulation accomplishes the foregoing by modulating the x-ray source #1 with a carrier frequency F1 while its associated focused two-dimensional curved detector array #1 demodulates the data around frequency F1 and recovers the patient intensity data. The adjacent x-ray sources 24 can be modulated simultaneously at different carrier frequencies so that complete separation of the modulated carriers can be accomplished with little distortion.

FIG. 21b is a frequency plot spectrum showing the major carrier frequencies F1, F2, and F3. As shown, the carrier frequency F1 data includes additional side bands corresponding to the patient's anatomy that is amplitude modulating the frequency F1 carrier. It should be noted that scattered x-ray data from carrier frequencies F2 and F3 are also present. These scattered x-ray data are not desirable and are rejected, as shown in FIG. 21c, which illustrates the final demodulated patient intensity data. In effect, the scattered x-ray signals from adjacent imaging heads have been rejected or nullified.

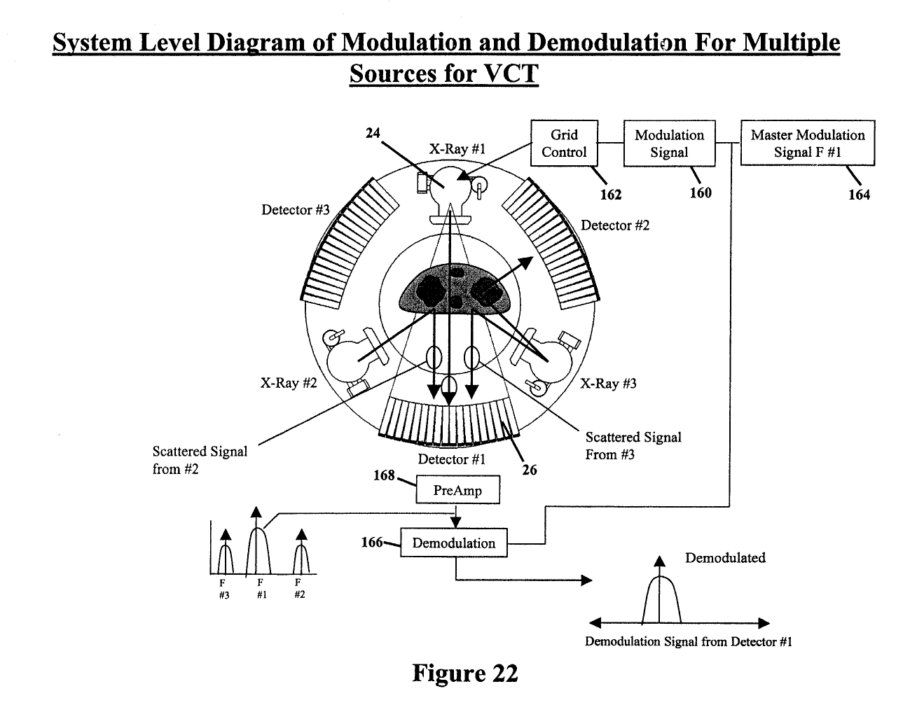

FIG. 22 illustrates the intensity modulation and demodulation of the x-ray sources 24 and their associated focused two-dimensional curved detector arrays 26 to reduce the effects of scattered x-ray radiation from multiple x-ray sources. As shown in FIG. 21, a system including three (3) imaging heads will have scattered x-ray radiation collected from adjacent imaging heads. The x-ray source #1 is controlled by the application of a modulation signal 160 to its grid control 162 which biases the anode of x-ray source #1 and modulates the intensity of the x-ray photons generated per unit of time by x-ray source #1. A master signal 164 is transmitted to a synchronous demodulation signal processor 166 having a pre-amplifier 168 associated therewith. The photons emitted by the x-ray source #1 are attenuated by the patient resulting in the effective amplitude modulation of the carrier frequency for the x-ray source #1. The signal processor 166 recovers the original patient intensity data and rejects scatter carrier frequencies from adjacent imaging heads.

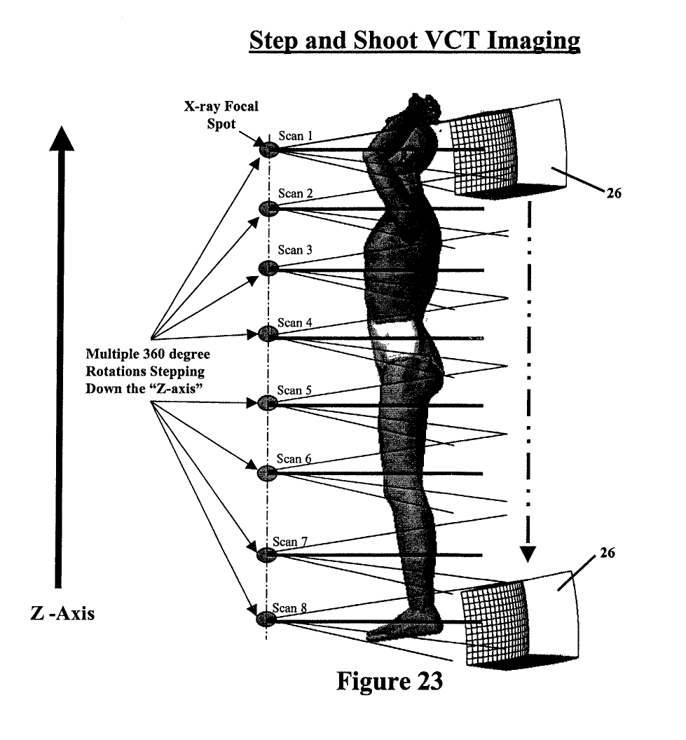

Step and shoot VCT imaging is illustrated in FIG. 23. The scan process is initiated in a starting position and 360 degrees of cone beam projection data are acquired. When data acquisition has been completed, the gantry 24 and the patient 30 are traversed relative to one another. The foregoing is the “step” process along the Z-axis. When the traversing motion has been completed, the acquisition of the VCT data, i.e., the “shoot” portion of the VCT imaging process, continues. The VCT data are then reconstructed and attached to one another to make a contiguous data set. In some reconstruction algorithms, projection data may be collected during the traversing motion in order to “fill-in” some of the truncated view space for cone beam reconstruction. Alternatively, data from a previous spiral scan may be used to “fill-in” some of the aforementioned truncated view space. Gated VCT reconstructions are accomplished by this method in order to obtain EKG gated images over a single or multi-cycle period.

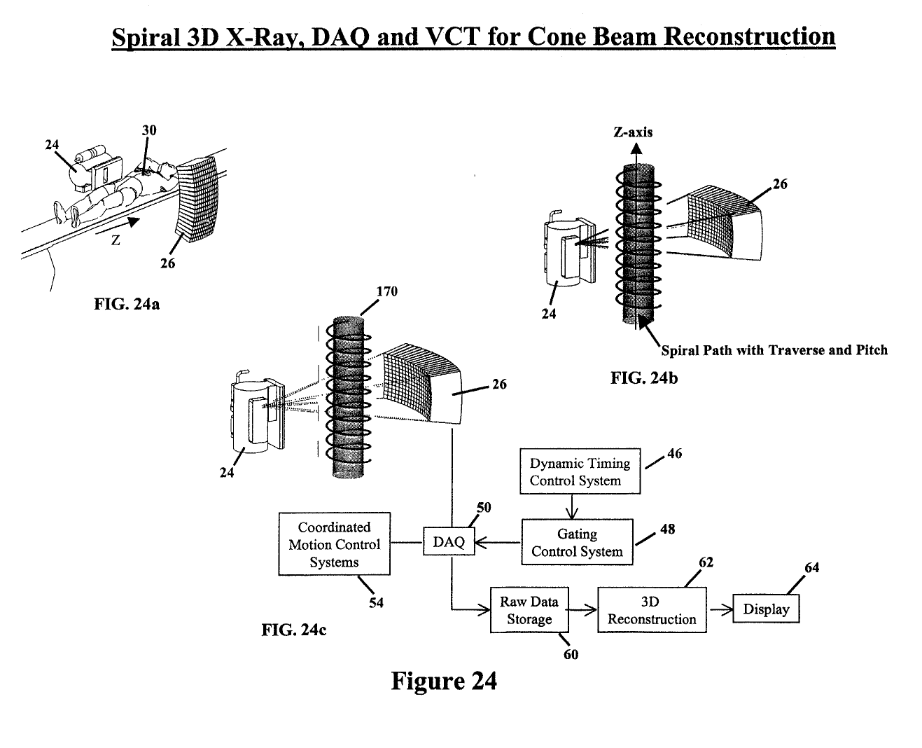

FIG. 24 illustrates the multi-modality imaging system 14 configured to perform spiral VCT, PET and NM/SPECT imaging. The concept of spiral imaging involves rotating the imaging heads while the patient is being traversed through the imaging field. Implementation of the foregoing starts with the planning system 44 that selects the anatomical area to be imaged. The term “pitch” is the ratio of the Z-axis travel of the patient 30 relative to the gantry 20 while the x-ray sources 24 and their associated focused two-dimensional curved detector arrays 26 are rotated one rotation around the patient. The Z-axis motions are synchronized with the rotating motions to allow precise geometry for sampling of the projection data for spiral cone beam reconstruction. With wider Z-axis coverage while utilizing cone beam imaging, the spiral pitch is related to the distance of the effective Z-axis detector width on an image reconstruction cylinder 170 traveling through 360 degrees of rotation.

In FIG. 24a, an x-ray source 24 and its associated focused two-dimensional curved detector array 26 are shown rotating around a patient 30. In FIG. 24b, the spiral path of the central ray of the cone beam is shown as the patient 30 traverses through the cone beam field of view. The Z-axis has been rotated 90 degrees for illustration purposes. The spiral pitch is equal to the distance that the patient 30 travels during a single revolution of the x-ray source 24 and its associated focused two-dimensional curved detector array 26. The spiral pitch factor is equal to the ratio of the (Z-axis travel)/(effective Z-axis detector width) during one revolution of the x-ray source 24 and its associated focused two-dimensional curved detector array 26. In FIG. 24c, the spiral data acquisition process is implemented with a traversing gantry 20, rotating x-ray sources 24 and associated focused two-dimensional curved detector arrays 26, the dynamic timing control system 46, gating control system 48, data acquisition system 50, motion control system 54, raw data management and storage system 60, image reconstruction system 62 and the image analysis and interactive display system 64. The three-dimensional spiral cone beam x-ray VCT images are generated from the spiral projection raw data and geometric motion information. Clinically useful spiral image reconstructions are achieved when each image voxel is exposed to at least 180 degrees of projection views while the spiral data are being acquired. The spiral projection views are mapped into virtual projection views that can be utilized with three-dimensional cone beam reconstruction algorithms. It should be noted that in this type of imaging process, a small amount of redundant view information is generated and weighting or normalization should be applied to the data to achieve clinically reasonable reconstructions. The three-dimensional cone beam spirals provide faster data acquisition times for whole body patient imaging and compensate for missing projection rays in step and shoot imaging with wide-angle cone beam three-dimensional computed tomography. The spiral rotational speed and the transverse speed of the table 22 can be synchronized to produce spiral image data that are synchronized to physiological signals and reference patient anatomy. Also, the spiral rotational speed and/or the transverse speed of the table 22 may be changed as a function of time to produce a spiral angio-graphic scan. The dynamic timing control system 46 controls the foregoing process and may monitor image contrast levels from the operator real-time image display and analysis system 66.

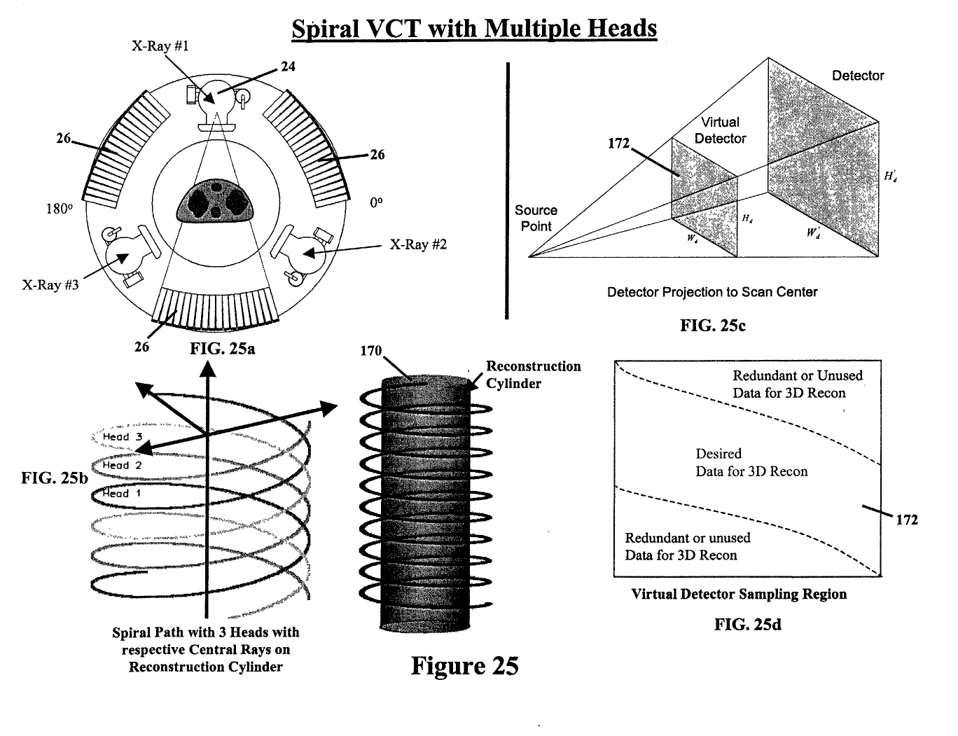

FIG. 25 illustrates the multi-modality imaging system 14 with multiple imaging heads. As previously indicated, an imaging head is defined as an x-ray source 24 and its associated focused two-dimensional curved detector array 26 attached to a rotate plate 28, as shown in FIG. 25a. As illustrated in FIG. 25b, the x-ray sources 24 and their associated focused two-dimensional curved detector arrays 26 create a spiral path on an image reconstruction cylinder 170 as the patient 30 traverses relative to the gantry 20 while multiple imaging heads are rotating thereabout. The first central rays are collected at 0 degrees, 120 degrees and 240 degrees. As the spiral scan progresses, the central ray of each imaging head makes a spiral path. The Z-axis height of the detector increases the coverage of the detector on the reconstruction cylinder 170 resulting in strips having a spiral configuration on the cylinder 170. The coverage of the strips on the reconstruction cylinder 170 can be considered to be a unique set of views making an image. If the images on the reconstruction cylinder 170 are projected onto a virtual detector 172 located at the center of the scan circle, as shown in FIG. 25c, the views do not occupy the entire rectangular detector region. The imaging information that is required is “windowed-out”, as shown in FIG. 25d, which represents a projection of the strips on the reconstruction cylinder 170 onto the virtual detector 172. It should be noted that the regions of redundant data or data that are not required are on the top and the bottom portions of the virtual detector 172 resulting in a unique weighting function for projection normalization, which must be done in these portions. It should also be noted that the collimation for the cone beam and the spiral scanning can be a slanted type of design such that only the desired data regions are exposed on the patient 30 and the redundant data portions are minimized.

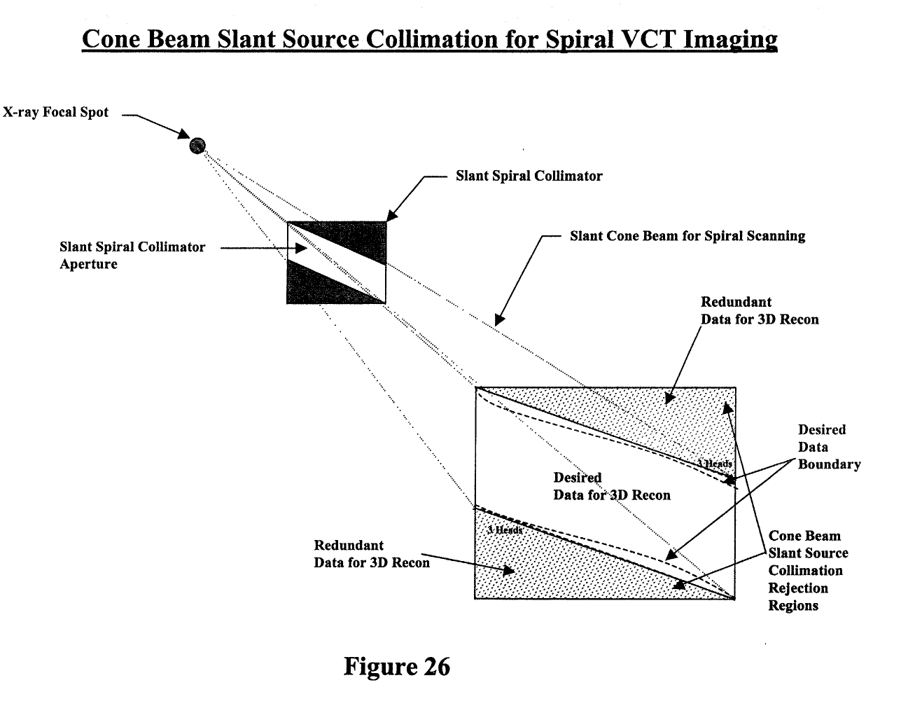

FIG. 26 illustrates cone beam slant source collimation for spiral VCT imaging. As previously described, the VCT spiral path requires that the data “fill in” the reconstruction cylinder 170. The desired data on the reconstruction cylinder 170 are then projected onto the virtual detector 172. The curved detector regions on the focused two-dimensional curved detector arrays 26 contain redundant data or data which may not be used. In some instances, it may be desired to use only non-redundant data. In order to accomplish the foregoing with dose efficiency, the cone beam is collimated from a rectangular format into a format such as a parallelogram by adjusting and rotating the cone beam fan collimation to the desired spiral cone beam shape. Spiral cone beam collimation is another function of the standard source collimation and also has the ability to project a rotated parallelogram flux distribution onto the surface of the focused two-dimensional curved detector array 26. Since the vertex of the focused two-dimensional curved detector array 26 is directed toward the focal spot of its associated x-ray source 24, source collimation can be accurately projected. The size and rotation angle of the spiral cone beam source collimation can be programmed and moved to the desired position for spiral cone beam imaging clinical protocols.

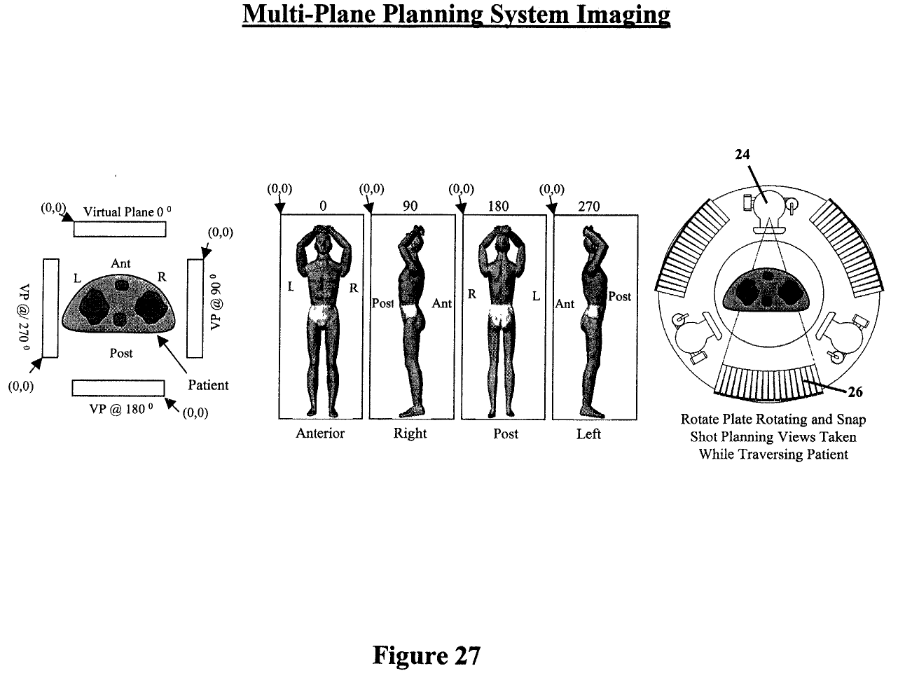

The imaging produced by the multi-plane planning system 44 is illustrated in FIG. 27. The purpose of the multi-plane planning system 44 is to acquire low dose x-ray whole body contiguous projection views in order to plan multi-modality imaging protocols. The views are collected while the patient 30 travels in the Z-axis direction relative to the gantry 20 and coordinated “snapshot” views are taken to generate major orthogonal views at 0, 90, 180, 270 degrees and to project the contiguous views on the monitors. After the whole body planning images have been taken, the operator selects protocols and regions to which the protocols are to be applied. Also, during this procedure, dosage levels are calculated and adaptive dose control information is generated for the respective protocols. The final step in this process involves interconnecting the protocols and transmitting the interconnected protocol information to the dynamic timing control system 46 for multi-modality imaging.

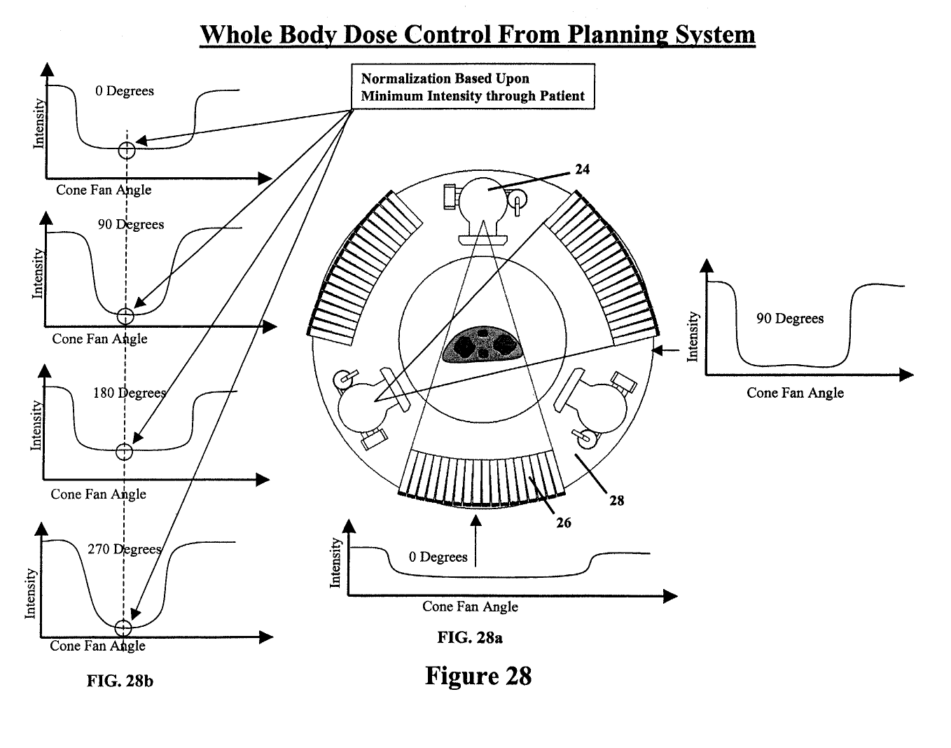

FIG. 28a illustrates adaptive whole body dose control initiated by the planning system 44. The major orthogonal images of the patient produced by the planning system 44 are utilized to compute the average skin dosage over the entire body of the patient. As shown in FIG. 28b, the intensity projection data from the patient is used to create projection normalization. The normalization is a function of the patient's size. Minimum intensities are used as one normalization metric. The dose control parameters are transmitted to the planning system 44 to adjust protocol mAs levels to achieve the desired image quality with minimum dosage to the patient. The dosage subsection of the planning system 44 predicts dosages based upon protocol selected and computes integral dosages based upon the interconnected protocols for VCT, gated VCT, and angio-graphic VCT, tri-phasic VCT, PET and NM/SPECT imaging. While the interconnected protocols are being executed, the dosage planning control information is transmitted to the data acquisition system 50 and is used to adaptively control mAs based upon patient physical morphology and to normalize noise levels throughout the VCT images. When each interconnected protocol has been completed, actual dosages are computed based upon procedure, VCT density, PET isotopes and NM/SPECT isotopes. The result is that the system receives actual dosage and predicted dosage for retention as part of the patient's history. This information is stored in a historical database for adaptive learning of new dosage control profiles for future patients.

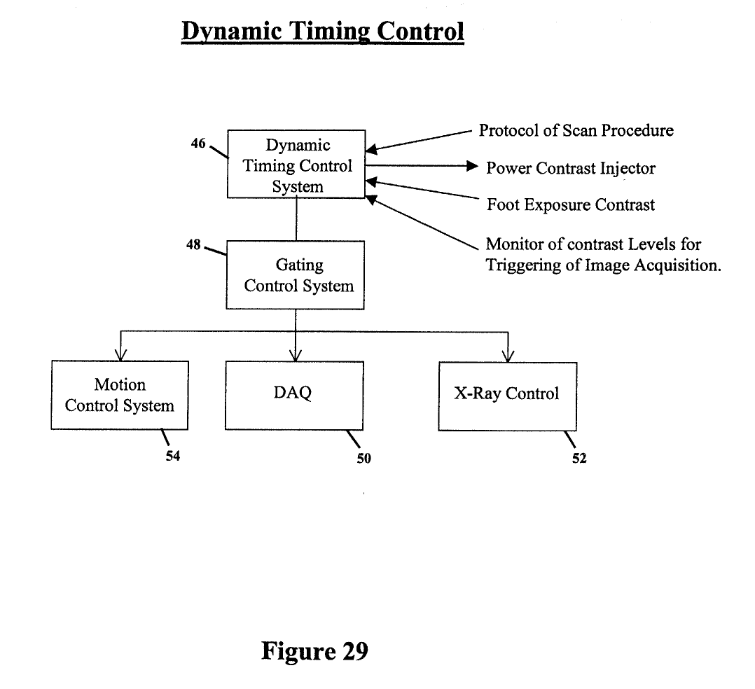

In FIG. 29, the dynamic timing control system 46 is shown connected to other major subsystems. The purpose of the timing control system 46 is to synchronize external patient interface devices and to provide control to the multi-modality image system major “real-time events”. Protocols of scan procedures are transmitted to the timing control system 46. Synchronization clocks are utilized to trigger events, such as contrast injection, foot pedal exposure control and patient breath hold signals. The timing control system 46 monitors contrast level in images to synchronize sampling in tri-phasic organ studies. Timing and event control data are transmitted via the gating control system 48, motion control system 54, data acquisition (DAQ) system 50 and x-ray control system 52 for low level multi-modality imaging control.

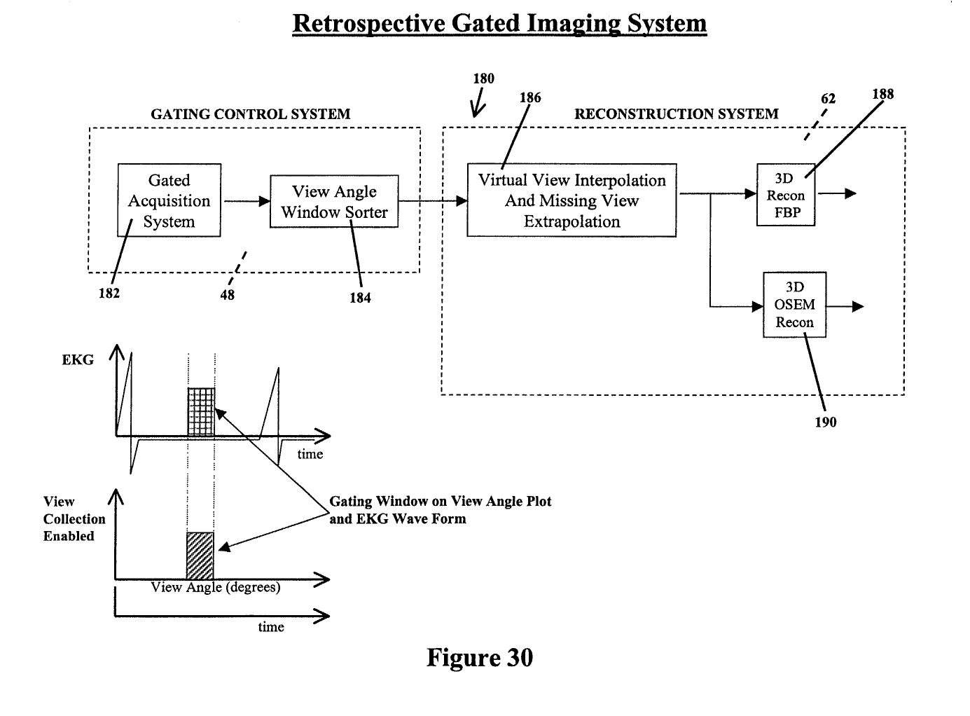

FIG. 30 is a block diagram illustrating the retrospective gated imaging system 180 which is comprised of the gating control system 48 and the image reconstruction system 62. The gating control system 48 is comprised of a gated acquisition system 182 and a view angle window sorter 184. The image reconstruction system 62 is comprised of a virtual view interpolator and missing view extrapolator 186 that produces images which are reconstructed by either a three-dimensional cone beam filtered back projection process 188 or a three-dimensional ordered subset expectation maximization (OSEM) reconstruction process 190. Physiological and imaging data are collected in the EKG gated mode of the gated imaging system 180. In the prospective mode of operation, the temporal gating window is sufficiently large to collect and process all needed views during one rotation of the x-ray sources 24 and their associated focused two-dimensional curved detector arrays 26. In the retrospective mode of operation, the temporal gating window is much smaller and multiple cardiac cycles are required in order to collect data in a contiguous form. In this latter mode of operation, the rotational speed of the x-ray sources 24 and their associated focused two-dimensional curved detector arrays 26 is controlled so as to be out-of-phase with the patient's cardiac cycle. This latter mode of operation permits small temporal window “snapshots” of the heart to be taken, and data are collected to produce a cine′ motion study of the entire cardiac heart cycle.

While the EKG retrospective imaging data acquisition is being performed, the view angle window sorter 184 sorts the views into the proper view location. The sorter 184 maps collected views and operates in real-time with the data acquisition process. The sorter 184 accepts the current set of views, along with EKG waveforms and system rotation dynamics, and calculates the next desired start view position for the rotate plate 28. The motion control system 54 is adjusted, along with the gating control system 48, to acquire the next set of views for the next cardiac and rotation cycle. When most of the views have been “filled-in”, the view angle window sorter 184 issues a command to terminate the data acquisition process. The data are then transferred to the virtual view interpolator and missing view extrapolator 186 which takes the EKG data, the VCT projection view data, and the view angle sorter data and generates virtual projection views. These views are then reconstructed by either the three-dimensional cone beam filtered back projection process 188 or the three-dimensional ordered subset expectation maximization reconstruction process 190.

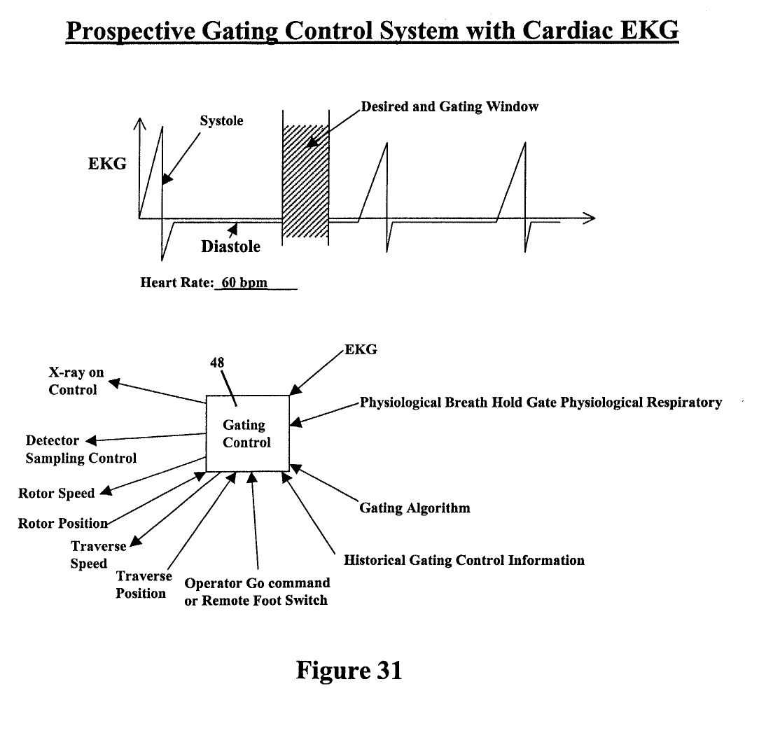

FIG. 31 illustrates the gating control system 48 in conjunction with cardiac EKG equipment. The input to the gating control system 48 includes EKG signals, a physiological breath hold gate, a physiological respiratory gate, a gating control algorithm, historical gating control information and operator “GO” commands or a remote foot switch commands. In addition, synchronizing motion control information, such as gantry position, rotate plate position and motion dynamics are inputs to the gating control system 48. The gating control system 48 transmits sampling commands to the data acquisition system 50, the x-ray control system 52 and the motion control system 54. The gating control system 48 also accepts inputs from the operator for gate window size and position, EKG waveform, average heart rate and the desired gating algorithm, such as prospective gating or retrospective gating. With this information, the gating control system 48 has direct control of all major data acquisition and imaging subsystems to sample, process and store gated images and temporal physiological sampling information.

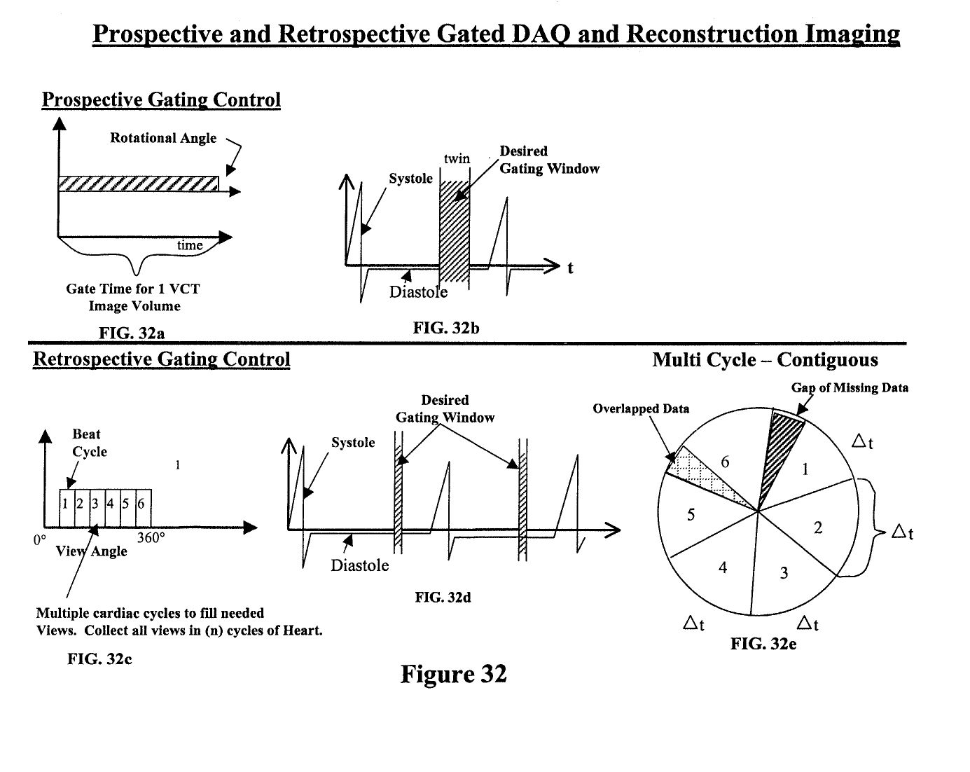

FIG. 32 illustrates prospective and retrospective gated data acquisition and reconstruction imaging. As illustrated in FIG. 32a, sufficient data to perform three-dimensional cone beam image reconstruction are collected during one rotation of the x-ray sources 24 and their associated focused two-dimensional curved detector arrays 26 in the prospective mode of operation. At least 180 degrees of rotation, plus some overlap, are required to obtain good image reconstruction, however, 360 degrees of views are more desirable. In FIG. 32b, the desired gating window is shown as a subset of time in the electrocardiogram (EKG) cycle. The diastole is usually chosen for minimal temporal blurring. Cardiac EKG waveform analysis and histogramming are accomplished as part of the overall gating control and are used to precisely control the gantry traverse motion, the rotational motion of the x-ray sources 24 and their associated focused two-dimensional curved detector arrays 26, and the data acquisition process. Multiple cardiac cycles are monitored and the average heart rate is determined. As the patient inhales and holds their breath, the cardiac rate increases. The gating histogram of the EKG is updated rapidly and when a stabilized rate has been achieved, the gating control system 48 starts the data acquisition process. The desired gating window is set on the average histogram display and in the diastolic region. Prospective gating acquisition begins automatically when gating stabilization has been achieved.

Retrospective gating control is utilized when smaller temporal gating windows or multiple gating windows for dynamic beating heart morphology are desired. In FIG. 32c, a smaller desired gating window is set and, in this instance, approximately six heart cycles are required in order to obtain enough views for a three-dimensional VCT image reconstruction. As illustrated, the rotational speed and the cardiac rate are out of synchronization by a small phase delay. In the desired view plot, the first 60 degrees of views are taken from the first cardiac cycle. Subsequently, on the next cardiac cycle and rotational cycle of the rotate plate 28, views from 60 degrees to 120 degrees are sampled. This process continues until 360 degrees of views are obtained through six cardiac and rotational cycles of the rotate plate 28. The gating control system 48 commands the motion control system 54 to adaptively adjust the rotational speed of the rotate plate 28 based upon the cardiac rate in order to acquire views at the correct position in the desired view diagram. It should be noted that in this instance, gating windows may be approximately six times smaller than with prospective gating control. The prospective gating window is limited by the rotational speed of the rotate plate 28 and the number of x-ray sources 24 and their associated focused two-dimensional curved detector arrays 26. For example, if the prospective gating window is 167 ms for a 0.5 second rotational cycle and three imaging heads are utilized, then the retrospective window will be 167 ms/6 or 27.8 ms.

The ability to compensate for gaps in view angles must be considered in the retrospective gating and image reconstruction processes. As patients are scanned, the cardiac cycle may shift unexpectedly while acquiring data. The gating control system 48 determines whether to continue with the acquisition of images or attempt to collect the desired views during the next cardiac cycle. This is illustrated in the desired view pie chart shown in FIG. 32e. As the gated scan cycle nears completion, the “fill in” of the pie chart approaches completion and some of the views will overlap causing redundant views to be generated. The retrospective gating reconstruction system compiles the views, EKG data and respiratory data to create the optimum three-dimensional VCT image reconstruction.

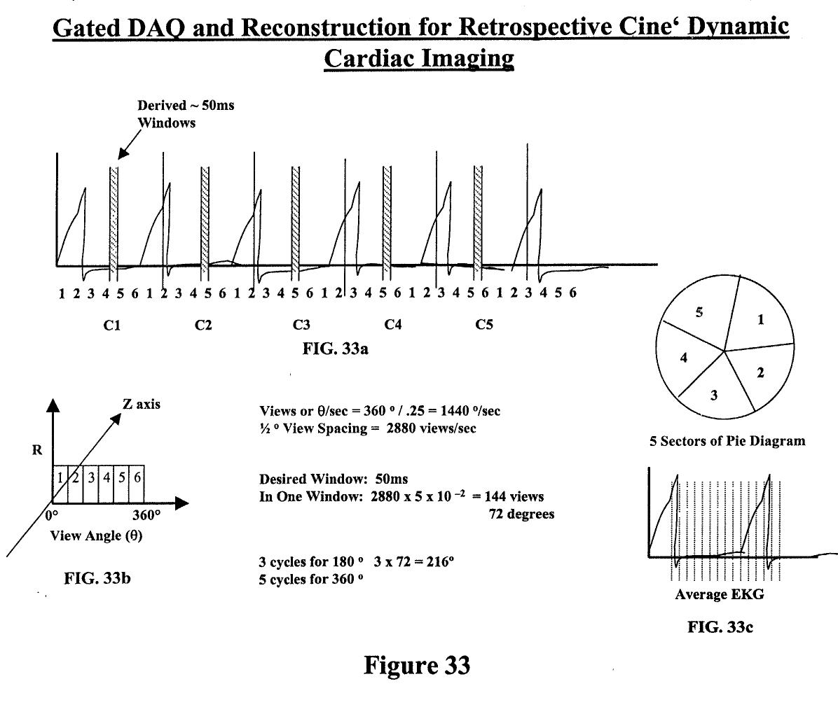

FIG. 33 illustrates gated data acquisition and image reconstruction for retrospective cine′ dynamic imaging. In FIG. 33a, the retrospective mode of operation collects sufficient data in five to six rotations of the rotate plate 28 in order to perform three-dimensional cone beam image reconstruction. At least 180 degrees, plus some overlapping view angle windows, are utilized to obtain beating heart cine′ VCT image reconstructions. The desired gating windows shown are a subset of time in the electrocardiogram (EKG) cycle. The entire cardiac cycle is used from the systolic through the diastolic period in order to minimize temporal blurring. Cardiac EKG waveform analysis and histogramming are undertaken as part of the overall gating control system. Multiple cardiac cycles are monitored and the average heart rate is determined. As the patient inhales and holds their breath, the cardiac rate increases, and the gating histogram of the EKG is updated rapidly. When a stabilized rate has been achieved, the gating control system 48 starts the data acquisition process.

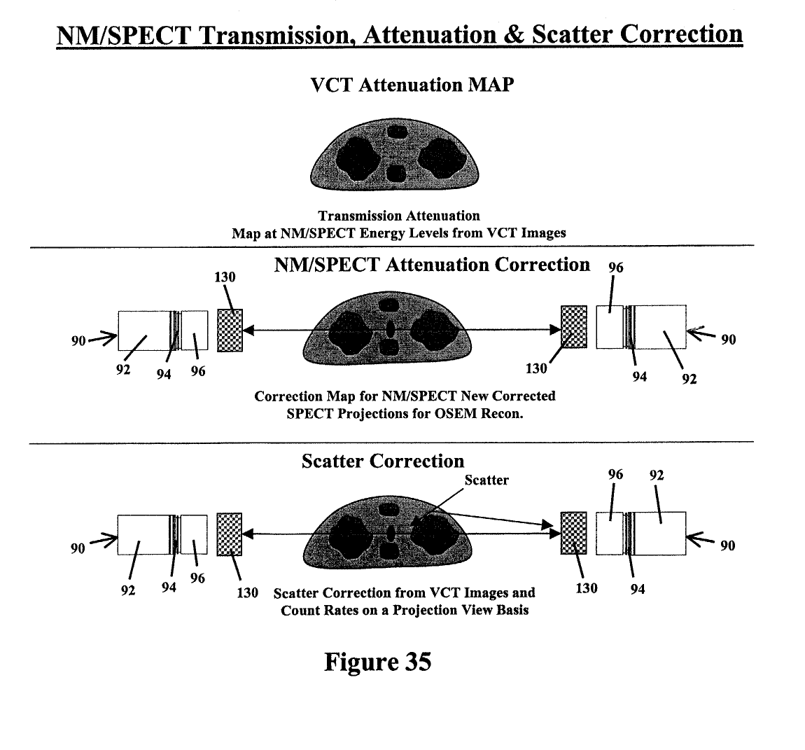

The desired gating windows, as shown in FIG. 33b, are set on the average histogram display and are distributed over the entire averaged cardiac cycle. Retrospective gating acquisition begins automatically when gating stabilization has been achieved. As shown, the desired gating temporal window size is 50 ms. If the average heart rate, at rest, is 60 beats per minute, one second or 1,000 ms, is required for a single average cardiac cycle. For continuous cine′ gated imaging, generally twenty separate windows are required for the entire cardiac cycle. To collect all of the necessary views, five cycles are required under ideal conditions. Each section of the view diagram requires 72 degrees, as shown in FIG. 35c. The x-ray sources 24 and their associated focused two-dimensional curved detector arrays 26 sample data continuously in order to compile the cine′ gated cardiac cycle raw data. The cine′ retrospective gated VCT image reconstruction methods utilize the multi-cycle retrospective data, EKG data, respiratory data and the aforementioned “pie chart” for each of the 50 ms windows and perform cine′ dynamic moving window gated VCT image reconstructions.

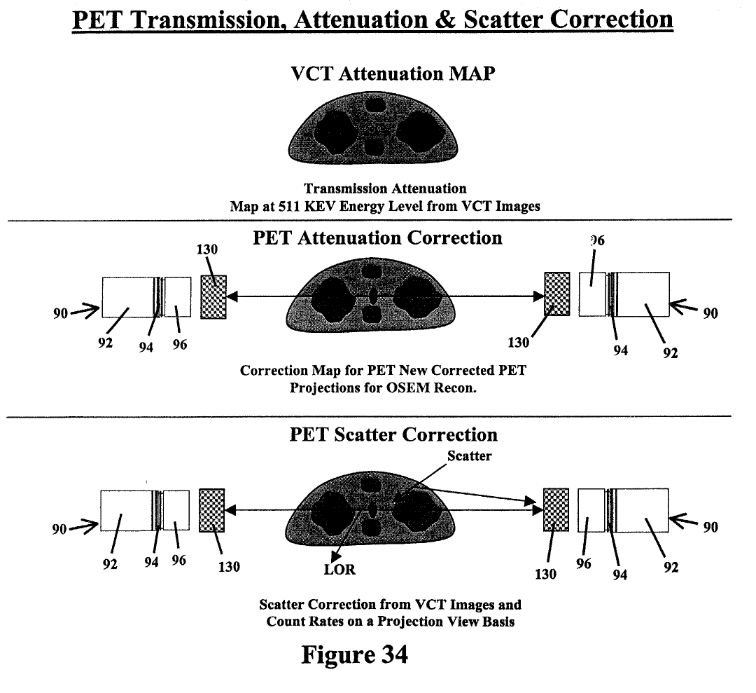

FIG. 34 illustrates PET transmission attenuation correction and scatter correction from geometrically registered VCT image and attenuation data. The VCT images are high quality images to be used for generation of attenuation maps at PET isotope energy levels. The three-dimensional 511 Kev attenuation maps are used by the PET image reconstruction system to correct for attenuation of the 511 Kev isotopes as they are being transmitted through the patient. The foregoing allows for better image presentation and permits the absorption of the isotopes in major organ systems and potential cancerous tumors to be quantified. The aforementioned quantification process is important in the detection and monitoring of therapeutic procedures to destroy disease processes. In addition, three-dimensional scatter corrections can be performed on the VCT image data that has been geometrically registered with the PET images. Compton scattered radiation effects and out-of-field random scattered radiation corrections can be performed adaptively based upon the patients' anatomy.

FIG. 35 illustrates NM/SPECT transmission attenuation correction and scatter correction from geometrically registered VCT image and attenuation data. The VCT images are high quality images for use in generating attenuation maps at NM/SPECT isotopes energy levels. The three-dimensional low energy attenuation maps, such as 140.5 Kev, are used by the NM/SPECT image reconstruction system to correct for attenuation of the low energy isotopes, such as 140.5 Kev, as they are being transmitted through the patient. The foregoing allows for better image presentation and permits the absorption of the isotopes in major organ systems and potential cancerous tumors to be quantified. This quantification process is important in the detection and monitoring of therapeutic procedures to destroy disease processes. Three-dimensional scatter corrections can be performed on the VCT image data that has been geometrically registered with the NM/SPECT images. Compton scattered radiation effects and out-of-field random scattered radiation corrections can be performed adaptively based upon the patients' anatomy.

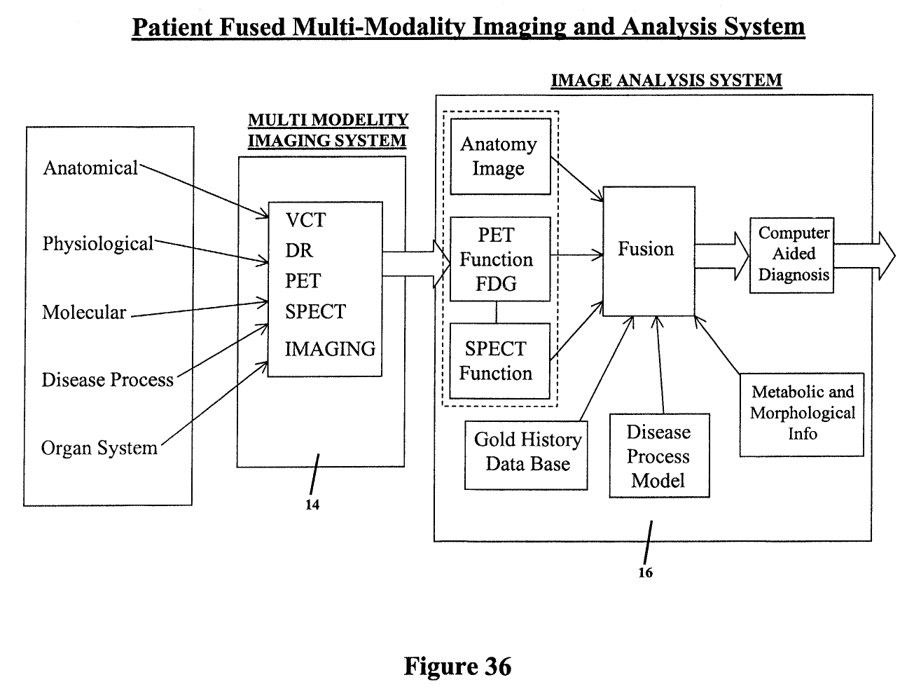

In FIG. 36, the multi-modality imaging system 14 produces x-ray VCT, DR, PET and NM/SPECT images of the patient. X-ray VCT and DR image data depict static and dynamic anatomical morphology of the patient with respect to time and contrast media injection. PET and NM/SPECT image data depict molecular, physiological and organ system function of the patient. Image data from the multi-modality imaging system 14 are transmitted to the multi-modality diffused imaging, analysis and computer aided diagnosis system 16. The multi-modality fused imaging, analysis and computer aided diagnosis system 16 undertakes fusion of the anatomical images, PET functional images, NM/SPECT functional images, gold history population databases, disease process models, and metabolic and morphological information. The fused information, along with clinical protocols, is presented to the patient, medical professionals and to a computer aided diagnosis system. All of the graphical image information and statistical population data and models are used to inform the patient and to provide an incentive to the patient to undertake preventive corrective measures and medical therapy.

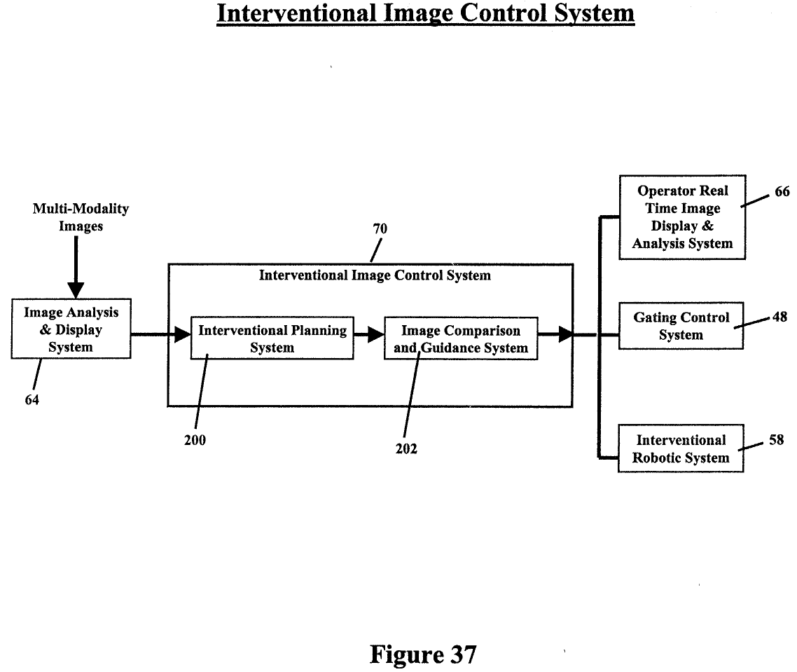

FIG. 37 illustrates the interventional image control system 70 utilized by the present invention. The multi-modality imaging system 14 has the capability of providing therapy through image guided interventional robotics and interventional needle placement. Images generated by the multi-modality imaging system 14, including VCT, PET and NM/SPECT images, are inputted into the interventional image control system 70, via the image analysis and display system 64, to interactively establish interventional procedures. The interventional image control system 70 is comprised of an interventional planning system 200 and an image comparison and guidance system 202.

Anatomical, functional and molecular imaging data are fused together to plan the desired interventional therapy. Geometric interventional plans are developed and simulated by this system. For example, the simulations may involve guiding a biopsy needle through anatomical structures to sample a tumor for biopsy purposes. The tumor may not be visible in x-ray anatomical data, but may be very visible in x-ray tri-phasic images or PET FDG images. The fusion of each of the respective anatomical, functional and molecular images provides a clear picture of the targeted volume of the tumor on which the biopsy is to be performed. The planned path for the percutaneous needle insertion is established by the interventional planning system 200. The simulation of the virtual biopsy is completed to ensure that the desired insertion path is realizable without harming any vital organs, blood vessels or skeletal structure.

Once the simulations have been completed, the image comparison and guidance system 202 starts the image guided interventional procedure. Control data produced by the image comparison and guidance system 202 are transmitted to the operator real-time image display and analysis system 66, the gating control system 48 and the interventional robotic system 58. The image guided procedure is accomplished interactively with the interventional image control system 70 monitoring and controlling the clinical procedure.

The interventional image control system 70 provides a feedback loop around the real-time interventional procedure. In addition, the interventional image control system 70 compares the actual path with the planned path and generates corrective information for the operator and for the interventional robotics system 58 to perform mid-course corrections. Furthermore, when the interventional procedure nears the target, verification of the position of the desired target with the actual target can be accomplished. When the procedure has been completed, the needle is retracted along the established path and the image comparison and guidance system 202 verifies the effectiveness of the procedure and whether any internal trauma, bleeding, etc. has occurred resulting from the performance of the minimally invasive surgical procedure.

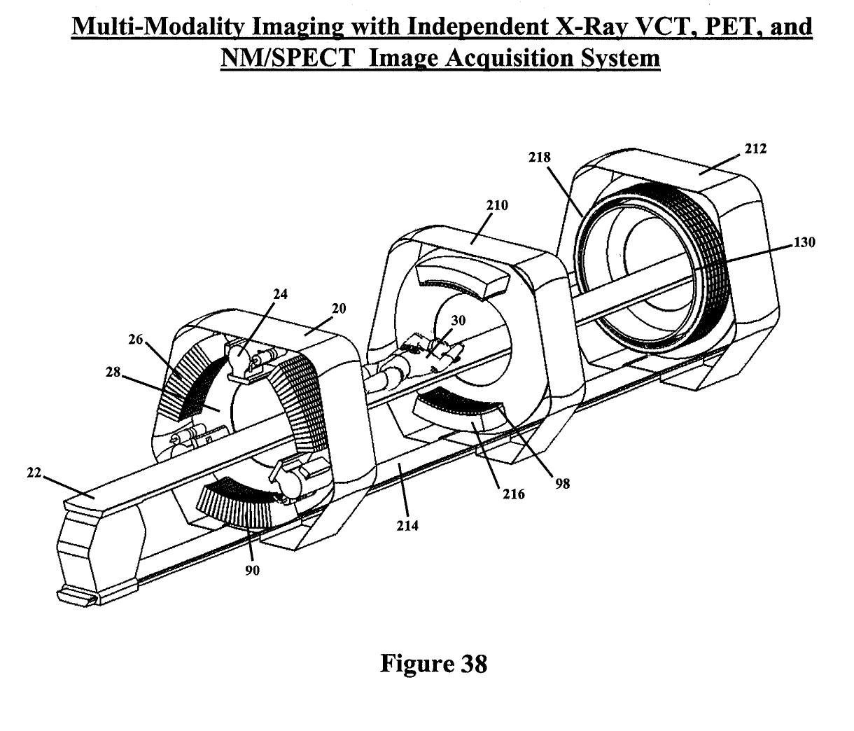

FIG. 38 illustrates an embodiment of the multi-modality imaging system 14 with separate VCT, PET, and NM/SPECT image acquisition units for higher patient throughput. The x-ray VCT gantry 20 utilizes three (3) x-ray VCT imaging heads, each head being comprised of an x-ray source 24 and a focused two-dimensional curved detector array 26 attached to a rotate plate 28 in the VCT gantry 20. The focused VCT two-dimensional curved detector modules 90 are optimized in their photo converters 94 and their signal processing section 96 for x-ray VCT only. In this case, the pulse processing signal circuitry for PET and NM/SPECT imaging may be eliminated or bypassed. The VCT gantry 20 is mechanically connected to an NM/SPECT gantry 210 and to a PET gantry 212 with a common patient table 22 and traversing gantry rail 214 or slide system. The patient 30 remains on the patient table 22 permitting substantially concurrent VCT, NM/SPECT and PET imaging acquisitions to be accomplished over the whole body of the patient.

The NM/SPECT gantry 210 utilizes focused curved gamma ray imaging detector modules 216 similar to the focused two-dimensional curved detector modules 90 used in the x-ray VCT gantry 20. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET gantry 212 utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

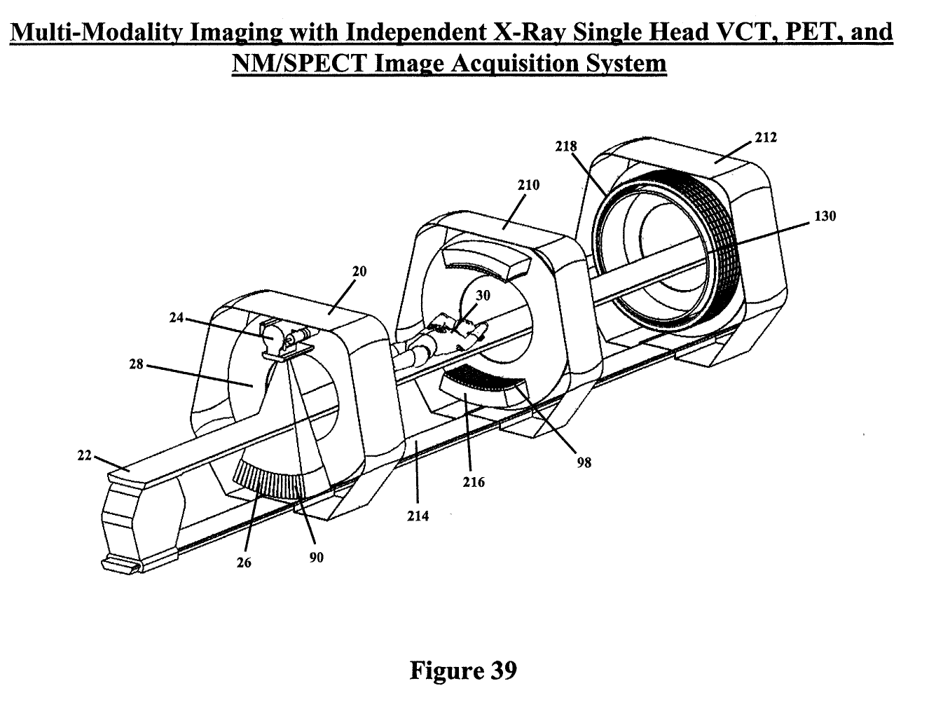

FIG. 39 illustrates another embodiment of the multi-modality imaging system 14 with separate VCT, PET, and NM/SPECT image acquisition units for higher patient throughput. In this case, the x-ray VCT gantry 20 utilizes a single x-ray VCT imaging head comprised of an x-ray source 24 and a focused two-dimensional curved detector array 26 attached to a rotate plate 28 in the VCT gantry 20. The VCT gantry 20 is mechanically connected to the NM/SPECT gantry 210 and to the PET gantry 212 with a common patient table 22 and a traversing gantry rail 214 or slide system.

Here again, the focused VCT two-dimensional curved detector modules 90 are optimized in their photo converters 94 and their signal processing sections 96 for x-ray VCT only. In this case, the pulse processing circuitry for PET and NM/SPECT imaging may be eliminated or bypassed. As in the previous embodiment shown in FIG. 38, the NM/SPECT gantry 210 utilizes focused curved gamma ray imaging detectors 216 similar to the focused two-dimensional curved detector modules 90 used in the x-ray VCT gantry 20. The focused curved gamma imaging ray detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET gantry 212 utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

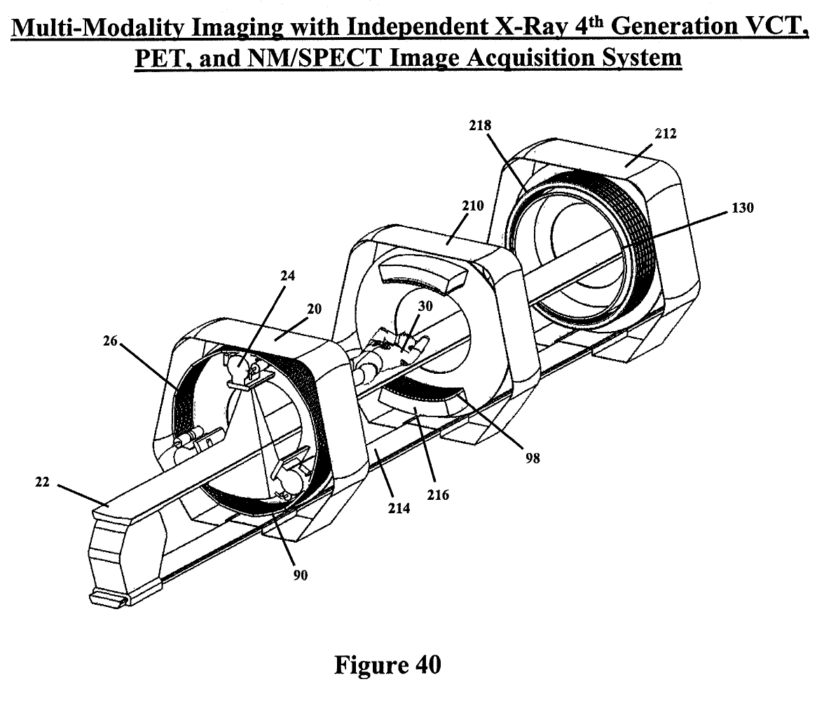

Still another embodiment of the multi-modality imaging system 14 with separate VCT, PET, and NM/SPECT image acquisition units for higher patient throughput is illustrated in FIG. 40. In this case, the x-ray VCT gantry 20 utilizes three (3) x-ray sources 24 attached to a rotate plate 28 and stationary focused two-dimensional curved detector arrays 26. The stationary focused two-dimensional curved detector arrays 26 are focused on the x-ray sources 24 in the transverse or Z-axis direction and on the center of rotation in the radial direction.

As in the two previous embodiments shown in FIGS. 38 and 39, the focused VCT two-dimensional curved detector modules 90 are optimized in their photo converters 94 and their signal processing sections 96 for x-ray VCT only. In this case, the pulse processing circuitry for PET and NM/SPECT imaging may be eliminated or bypassed. Here again, the NM/SPECT gantry 210 utilizes focused curved gamma ray imaging detector modules 216 similar to the focused two-dimensional curved detector modules 90 used in the x-ray VCT gantry 20. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator98 is placed in front of the focused curved gamma ray imaging detector modules 216.

The PET gantry 212 utilizes PET curved detector modules 218 which have pixel channel processing capabilities similar to that used in NM/SPECT imaging. Both the PET curved detector module 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 convert the 511 Kev energies efficiently on an independent channel basis. The anti-scatter baffle 130 is utilized to reduce out-of-field Compton scattered radiation from both NM/SPECT and PET isotopes.

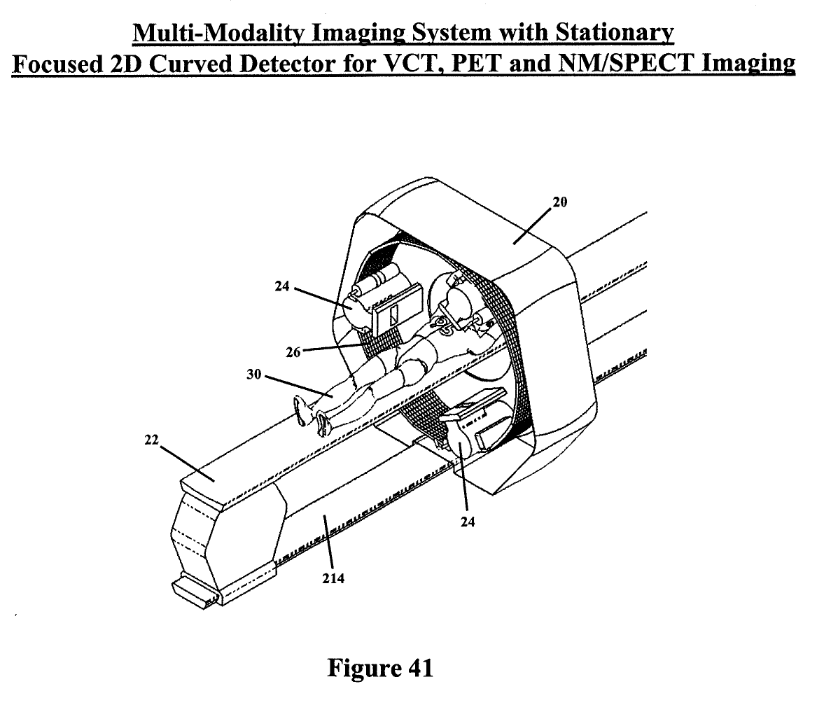

FIG. 41 is an illustration of an x-ray VCT image acquisition unit utilizing three (3) x-ray sources 24 mounted on the rotate plate 28 and stationary focused two-dimensional curved detector arrays 26, as illustrated in FIG. 40. The stationary focused two-dimensional curved detector arrays 26 are focused on the x-ray sources 24 in the transverse of Z-axis direction and on the center of rotation in the radial direction.

The gantry 20 with the stationary focused two-dimensional curved detector arrays 26 are mechanically connected to the patient table 22 and the traversing gantry rail 214 or slide system. The patient 30 remains on the patient table 22 permitting substantially concurrent VCT, NM/SPECT and PET imaging acquisitions to be accomplished over the whole body of the patient.

In the NM/SPECT mode of operation, the stationary focused two-dimensional curved detector arrays 26 are designed so as to be able to operate with both NM/SPECT and PET isotopes being in the patient simultaneously. A cone beam NM/SPECT collimator 98 is placed in front of the stationary focused two-dimensional curved detector arrays 26.

The PET mode of operation utilizes multi-ring PET imaging with stationary focused two-dimensional curved detector arrays 26 having pixel channel signal processing capabilities similar to that used in the NM/SPECT mode of operation. Both the PET and the NM/SPECT stationary focused two-dimensional curved detector arrays 26 utilize independent channel processing for high count rate capability.

The stationary focused two-dimensional curved detector arrays 26 include photo converters to efficiently convert the 511 Kev energies on an independent channel basis. An anti-scatter baffle is utilized to reduce out-of-field Compton scattered radiation from both NM/SPECT and PET isotopes.

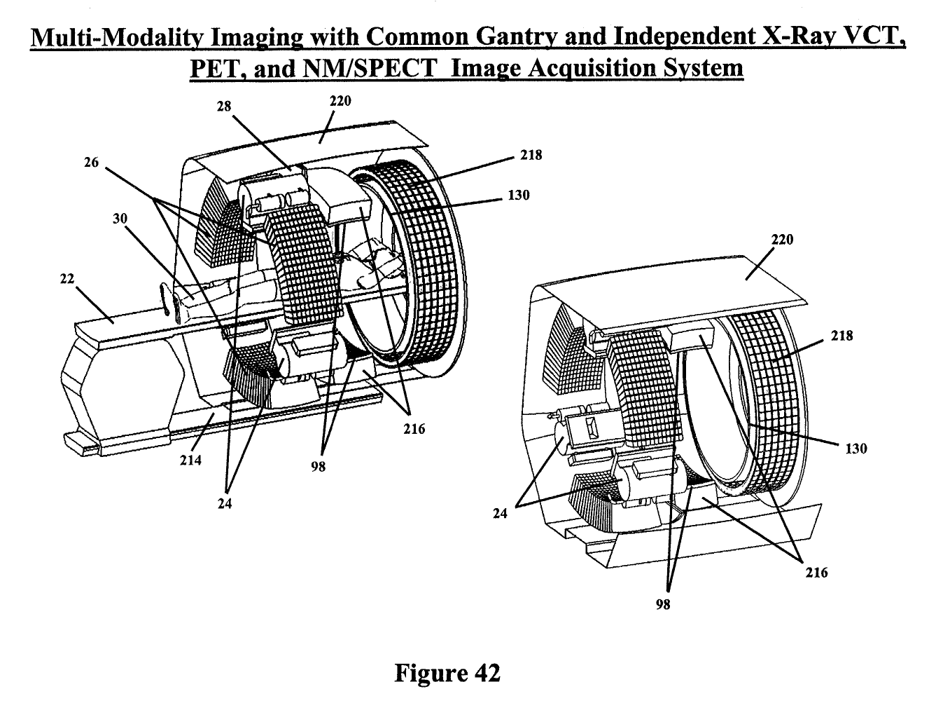

FIG. 42 illustrates an embodiment of the multi-modality imaging system 14 with separate VCT, PET, and NM/SPECT image acquisition units and utilizing a common gantry 220 for enclosing the VCT, PET, and NM/SPECT image acquisition units. The VCT image acquisition unit utilizes three (3) x-ray VCT imaging heads, each head being comprised of an x-ray source 24 and a focused two-dimensional curved detector array 26 attached to a rotate plate 28. The focused VCT two-dimensional curved detector modules 90 are optimized in their photoconverters 94 and their signal processing sections 96 for x-ray VCT only. In this case, the pulse processing signal circuitry for PET and NM/SPECT imaging may be eliminated or bypassed. The VCT, NM/SPECT, and PET imaging units are interconnected and utilize a common patient table 22 and a traversing gantry rail 214 or slide system. The patient 30 remains on the patient table 22 permitting substantially concurrent VCT, NM/SPECT and PET imaging acquisitions to be accomplished over the whole body of the patient.

The NM/SPECT imaging unit utilizes focused curved gamma ray imaging detector modules 216 similar to the focused two-dimensional curved detector modules 90 used in the x-ray VCT imaging unit. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET imaging unit utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

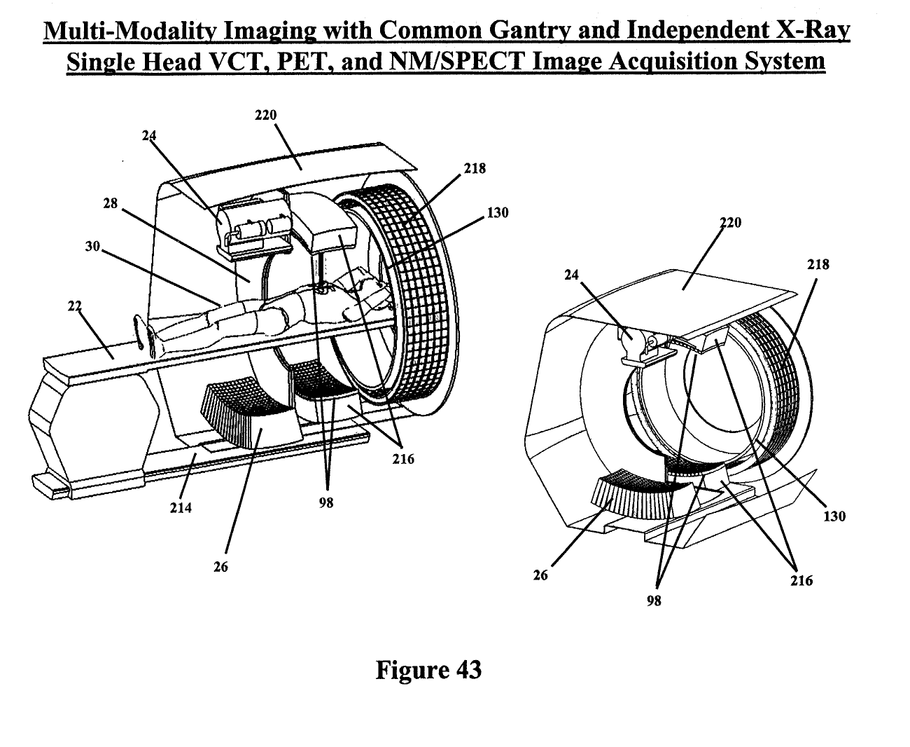

FIG. 43 illustrates another embodiment of the multi-modality imaging system 14 with separate VCT, PET, and NM/SPECT image acquisition units for higher patient throughput. In this case, the VCT, PET, and NM/SPECT image acquisition units are housed within a common gantry 220. In addition, the VCT image acquisition unit utilizes a single x-ray VCT imaging head comprised of a x-ray source 24 and a focused two-dimensional curved detector array 26 attached to a rotate plate 28. The VCT image acquisition unit is mechanically connected to the NM/SPECT image acquisition unit and the PET image acquisition unit and the image acquisition units utilize a common patient table 22 and a traversing gantry rail 214 or slide system.

The NM/SPECT imaging unit utilizes focused curved gamma ray imaging detector modules 216 similar to the focused two-dimensional curved detector modules 90 used in the x-ray VCT imaging unit. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET imaging unit utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

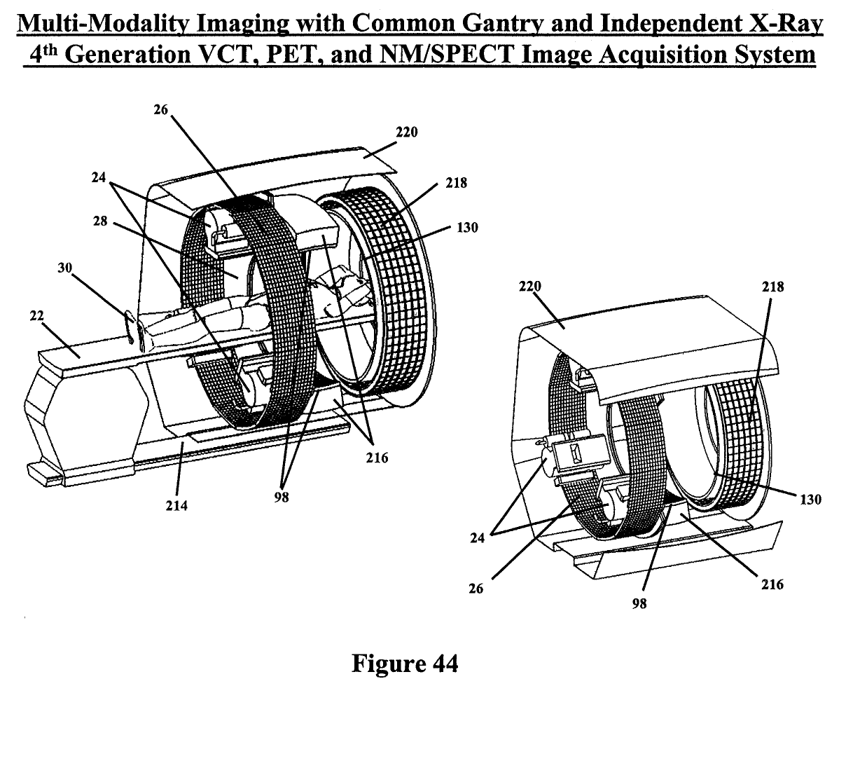

Still another embodiment of the multi-modality imaging system 14 with separate VCT, PET, and NM/SPECT image acquisition units for higher throughput is illustrated in FIG. 44. As in the two previous embodiments shown in FIGS. 42 and 43, the VCT, PET, and NM/SPECT image acquisition units are housed within a common gantry 220. In this case, the x-ray VCT image acquisition unit utilizes three (3) x-ray sources attached to a rotate plate 28 and stationary focused two-dimensional curved detector arrays 26. The VCT, NM/SPECT, and PET imaging units are mechanically interconnected and utilize a common patient table 22 and a traversing gantry rail 214 or slide system. The stationary focused two-dimensional curved detector arrays 26 are focused on the ray sources 24 in the transverse or Z-axis direction and on the center of rotation in the radial direction.

The NM/SPECT imaging unit utilizes focused curved gamma ray imaging detector modules 216 similar to the focused two-dimensional curved detector modules 90 used in the x-ray VCT imaging unit. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET imaging unit utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

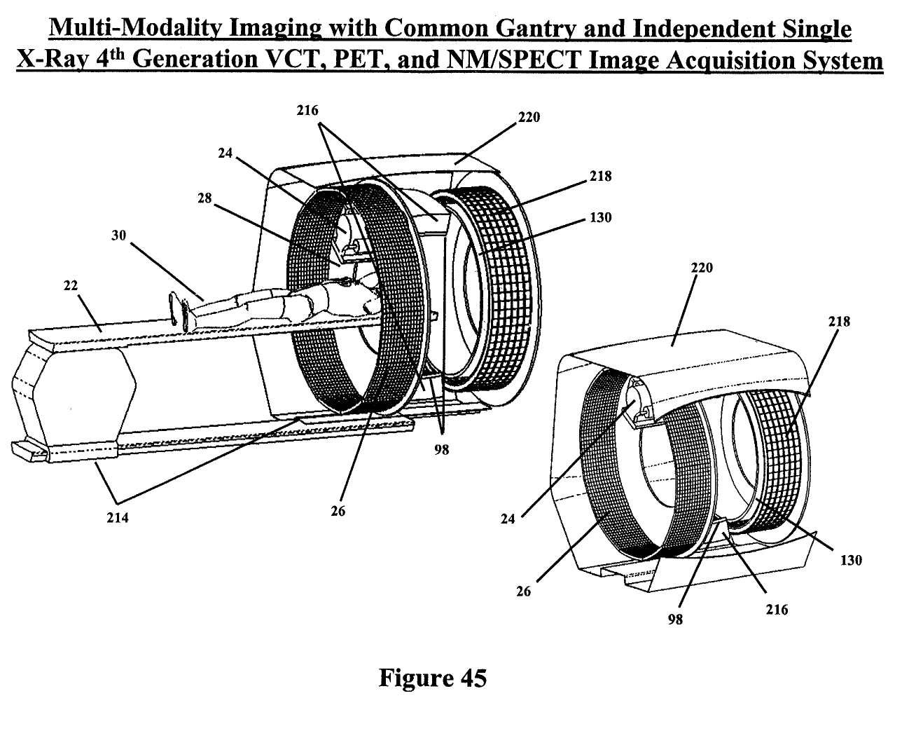

FIG. 45 illustrates still another embodiment of the multi-modality imaging system 14 with separate VCT, PET, and NM/SPECT image acquisition units for higher patient throughput. As in the three previous embodiments shown in FIGS. 42, 43 and 44, the VCT, PET, and NM/SPECT image acquisition units are housed within a common gantry 220. In this case, the x-ray VCT imaging unit utilizes a single x-ray VCT imaging head comprised of an x-ray source 24 mounted on the rotate plate 28 and a stationary focused two-dimensional curved detector arrays 26 attached to a common gantry 220. The VCT image acquisition unit is mechanically connected to the NM/SPECT image acquisition unit and the PET image acquisition unit and the image acquisition units utilize a common patient table 22 and a traversing gantry rail 214 or slide system. The focused two-dimensional curved detector arrays 26 are focused on the x-ray sources in the transverse or Z-axis direction and on the center of rotation in the radial direction.

The NM/SPECT imaging unit utilizes focused curved gamma ray imaging detector modules 216 similar to the focused two-dimensional curved detector modules 90 used in the x-ray VCT imaging unit. The focused curved gamma ray imaging detector modules 216 are optimized to image NM/SPECT isotopes and are operationally different from the focused VCT two-dimensional curved detector modules 90. The focused curved gamma ray imaging detector modules 216 are functionally equivalent to the focused VCT two-dimensional curved detector modules 90, however, their photo converter sections are adapted for NM/SPECT imaging only. The focused curved gamma ray imaging detector modules 216 are mounted and designed to operate with both NM/SPECT and PET isotopes being within the patient simultaneously. The focused curved gamma ray imaging detector modules 216 may be translated radially to permit higher spatial resolution cone beam NM/SPECT imaging. A cone beam NM/SPECT collimator 98 is placed in front of the focused curved gamma ray imaging detector modules 216.

The PET imaging unit utilizes PET curved detector modules 218 which have pixel channel processing capabilities similar to that used in NM/SPECT imaging. Both the PET curved detector modules 218 and the NM/SPECT focused curved gamma ray imaging detector modules 216 utilize independent channel processing for high count rate capability. The PET curved detector modules 218 are optimized to image PET isotopes and are operationally different from the focused VCT two-dimensional curved detector modules 90. The PET curved detector modules 218 are functionally equivalent to the focused VCT two-dimensional curved detector modules 90, however, their photo converter sections are adapted for PET imaging only. The photo converters in the PET curved detector modules 218 efficiently convert the 511 Kev energies on an independent channel basis. The anti-scatter baffle 130 is utilized to reduce out-of-field Compton scattered radiation from both NM/SPECT and PET isotopes.

Certain modifications and improvements will occur to those skilled in the art upon reading the foregoing. It is understood that all such modifications and improvements have been deleted herein for the sake of conciseness and readability, but are properly within the scope of the following claims.

We claim:

1) A multiple modality imaging system capable of operating in the VCT, DR, PET and NM/SPECT modes of operation comprising:
a) at least one gantry;
b) a table for supporting and positioning a patient relative to said at least one gantry;
c) at least one x-ray source rotatable with respect to said at least one gantry and to said table;
d) a configuration of focused two-dimensional curved detector arrays positioned to detect x-rays produced by said at least one x-ray source when the system is in the VCT and DR modes of operation, to detect coincident gamma rays when the system is in the PET mode of operation, and to detect single photon gamma rays when the system is in the NM/SPECT mode of operation;
e) means for selecting the mode of operation of said system, said selecting means comprising means for controlling the relative lateral movement between said at least one gantry and said table and the rotational movement of said at least one x-ray source with respect to said at least one gantry and to said table;
f) a collection system to acquire data received by said configuration of focused two-dimensional curved detector arrays; and
g) a reconstruction system to process data acquired by said collection system.

2) The imaging system as defined in claim 1 further including a plate member supported by said at least one gantry and rotatable with respect to said at least one gantry, said at least one x-ray source and said configuration of focused two-dimensional curved detector arrays being operatively attached to said plate member.

3) The imaging system as defined in claim 1 further including a plate member supported by said at least one gantry and rotatable with respect to said at least one gantry, wherein said configuration of focused two-dimensional curved detector arrays comprises a first set of curved detector arrays to detect x-rays produced by said at least one x-ray source when the system is in the VCT and DR modes of operation, said first set of curved detector arrays and said at least one x-ray source being operatively attached to said plate member, a second set of detector arrays to detect coincident gamma rays when the system is in the PET mode of operation, and a third set of detector arrays to detect single photon gamma rays when the system is in the NM/SPECT mode of operation.

4) The imaging system as defined in claim 1 further including a plate member supported by said at least one gantry and rotatable with respect to said at least one gantry, said at least one x-ray source being operatively attached to said plate member, and said configuration of focused two-dimensional curved detector arrays being mounted to said at least one gantry and being substantially stationary with respect to said at least one gantry.

5) The imaging system as defined in claim 1 further including a plate member supported by said at least one gantry and rotatable with respect to said at least one gantry, said at least one x-ray source being operatively attached to said plate member, said configuration of focused two-dimensional curved detector arrays being mounted to said at least one gantry and being substantially stationary with respect to said at least one gantry, and wherein said configuration of focused two-dimensional curved detector arrays comprises a first set of curved detector arrays to detect x-rays produced by said at least one x-ray source when the system is in the VCT and DR modes of operation, a second set of curved detector arrays to detect coincident gamma rays when the system is in the PET mode of operation, and a third set of curved detector arrays to detect single photon gamma rays when the system is in the NM/SPECT mode of operation.

6) The imaging system as defined in claim 1 wherein said at least one x-ray source is a single x-ray source and further including a plate member supported by said at least one gantry and rotatable with respect to said at least one gantry, wherein said configuration of focused two-dimensional curved detector arrays comprises a first single curved detector array to detect x-rays produced by said single x-ray source when the system is in the VCT and DR modes of operation, said first single curved detector array and said single x-ray source being operatively attached to said plate member, a second set of detector arrays to detect coincident gamma rays when the system is in the PET mode of operation, and a third set of detector arrays to detect single photon gamma rays when the system is in the NM/SPECT mode of operation.

7) The imaging system as defined in claim 1 wherein said at least one x-ray source is a single x-ray source and further including a plate member supported by said at least one gantry and rotatable with respect to said at least one gantry, said single x-ray source being operatively attached to said plate member, said configuration of focused two-dimensional curved detector arrays being mounted to said at least one gantry and being substantially stationary with respect to said at least one gantry, and wherein said configuration of focused, two-dimensional curved detector arrays comprises a first set of curved detector arrays to detect x-rays produced by said single x-ray source when the system is in the VCT and DR modes of operation, a second set of detector arrays to detect coincident gamma rays when the system is in the PET mode of operation, and a third set of detector arrays to detect single photon gamma arrays when the system is in the NM/SPECT mode of operation.

8) The imaging system as defined in claim 1 wherein said at least one x-ray source comprises a plurality of x-ray sources and further including a sequencing control system permitting any number of said x-ray sources within said plurality of x-ray sources to be simultaneously activated.

9) The imaging system as defined in claim 1 further including a scatter rejection device operatively connected to said configuration of focused two-dimensional curved detector arrays, said scatter rejection device operable to reject those x-rays produced by said at least one x-ray source that have been scattered outside a pre-determined area.

10) The imaging system as defined in claim 1 further including a scatter correction device operatively connected to said configuration of focused two-dimensional curved detector arrays, said scatter correction device operable to collimate single photon gamma rays when the system is in the NM/SPECT mode of operation.

11) The imaging system and defined in claim 1 further including a collimation device interposed between the patient and said configuration of focused two-dimensional curved detector arrays, said collimation device operable to improve the spatial resolution, sensitivity and energy range of single photon gamma rays when the system is in the NM/SPECT mode of operation.

12) The imaging system as defined in claim 1 wherein said configuration of focused two-dimensional curved detector arrays is positioned so as to minimize spatial resolution reduction from a central axis to the maximal axis regions of a pre-determined area so as to produce an image comprised of pixel elements, each of said pixel elements being optimally focused towards its respective x-ray source to receive the optimum number of x-rays in said pre-determined area.

13) The imaging system as defined in claim 12 wherein a selectable optical response of said pixel elements to x-rays is shaped to improve the spatial and contrast resolution characteristics of the resulting images.

14) The imaging system as defined in claim 1 wherein said configuration of focused two-dimensional curved detector arrays is positioned to minimize spatial resolution reduction from a central axis to the maximal axis regions of a pre-determined area, and wherein said at least one x-ray source has an anode with a surface having at least one V-shaped groove therein to produce at least one focal spot and wherein the resulting images are comprised of pixel elements, each of said pixel elements being of a substantially constant radius and optimally focused toward its respective x-ray source focal spots, said x-ray focal spots being generated by said at least one x-ray source to achieve resolution in said pre-determined area.

15) The imaging system as defined in claim 14 further including apparatus to geometrically dither said at least one focal spot to improve sampling and spatial resolution of the resulting images.

16) The imaging system as defined in claim 14 further including apparatus to geometrically dither said configuration of focused two-dimensional curved detector arrays in the X and Z directions to improve sampling and spatial resolution of the resulting images.

17) The imaging system as defined in claim 1 wherein said at least one x-ray source is a plurality of x-ray sources and further including means to correct x-ray scatter, said x-ray scatter correction means causing a single x-ray source within said plurality of x-ray sources to be activated while the remaining x-ray sources in said plurality of x-ray sources are deactivated allowing those detector arrays in said configuration of focused two-dimensional curved detector arrays that are outside the x-ray path to detect scattered x-rays permitting real-time adaptive x-ray scatter correction.

18) The imaging system as defined in claim 1 wherein said at least one x-ray source produces a focal spot signal and further including an x-ray scatter rejection system comprising means to modulate the intensity of each focal spot signal produced by said at least one x-ray source with a signal assigned thereto, means for demodulating a detected signal from each intensity modulated focal spot signal having said assigned signal, and means for processing said demodulated detected signal to produce a signal having reduced scatter.

19) The imaging system as defined in claim 1 further including control apparatus including a gating system to synchronize data acquisition with an external physiological event, said gating system controlling the timing of said at least one x-ray source and said configuration of focused, two-dimensional curved detector arrays to acquire data based upon said external physiological event, said gating system supplying signals to said selecting means to synchronize the movement of said at least one gantry and said table with said external physiological event.

20) The imaging system as defined in claim 1 further including a dynamic timing control system programmed with a time series of control events to perform precise dynamic imaging procedures when the system is in the VCT, spiral VCT, DR, PET and NM/SPECT modes of operation, said dynamic timing control system monitoring contrasting agent material flow through the patient and synchronizing data acquisition, VCT imaging rate, variable spiral VCT imaging rate, x-ray dose/mAs levels, with physiological events.

21) The imaging system as defined in claim 1 further including an injector apparatus for injecting contrasting material or radio-isotopes into the patient, a gating system and a dynamic timing control system, said injector apparatus injecting contrasting materials into the patient at a predetermined time and being controlled by said gating system and said dynamic timing control system.

22) The imaging system as defined in claim 1 further including a gated data image acquisition and reconstruction system for performing retrospective and prospective cardiac and vascular imaging, said gated data image acquisition and reconstruction system using data received by said collection system to produce images in a prospective mode to form a cine′ view of a gated time set of x-ray VCT volume images of cardiac and vascular functions, said gated data image acquisition and reconstruction system using data received by said collection system to produce images in a retrospective mode to form a cine′ view of a gated time set of x-ray VCT volume images of cardiac and vascular functions utilizing multiple sequential cardiac cycles to produce relatively shorter temporal volume images than in said prospective mode of operation.

23) The imaging system as defined in claim 1 further including a gated data image acquisition and reconstruction system for performing retrospective and prospective cardiac and vascular imaging, said gated data image acquisition and reconstruction system using data received by said collection system to produce images in a retrospective mode to form a cine′ view of a gated time set of NM/SPECT volume images of cardiac and vascular functions utilizing multiple sequential cardiac cycles, and said gated data image acquisition and reconstruction system using data received by said collection system to produce images in a retrospective mode to form a cine′ view of a gated time set of NM/SPECT volume images of cardiac and vascular functions utilizing multiple sequential cardiac cycles.

24) The imaging system as defined in claim 1 further including a gated data image acquisition and reconstruction system for performing retrospective and prospective cardiac and vascular imaging, said gated data image acquisition and reconstruction system using data received by said collection system to produce images in a retrospective mode to form a cine′ view of a gated time set of PET volume images of cardiac and vascular functions utilizing multiple sequential cardiac cycles, and said gated data image acquisition and reconstruction system using data received by said collection system to produce images in a retrospective mode to form a cine′ view of a gated time set of PET volume images of cardiac and vascular functions utilizing multiple sequential cardiac cycles.

25) The imaging system as defined in claim 1 wherein said reconstruction system uses data received by said collection system to reconstruct images from a helical volume spiral acquisition mode to produce whole body x-ray VCT volume images, said reconstruction system selecting data for helical spiral reconstructions while utilizing dose efficient angled cone-beam collimation, said reconstruction system processing imaging data while utilizing redundant data.

26) The imaging system as defined in claim 1 wherein said reconstruction system performs step and shoot VCT volume image reconstruction with isotropic spatial resolution.

27) The imaging system as defined in claim 26 wherein said step and shoot VCT volume image reconstruction utilizes traverse line projection data or spiral imaging data to fill in truncated view space so as to improve said volume image reconstructions.

28) The imaging system as defined in claim 1 further including an x-ray whole body planning system permitting the acquisition of images from a multiplicity of angles while traversing the whole body of a patient to produce single, bi-plane, or multi-plane whole body projection images which are utilized to plan subsequent multi-modality imaging procedures.

29) The imaging system as defined in claim 28 further including an adaptive x-ray dose control system using data received by said collection system to optimize patient dosage and desired image quality prospectively.

30) The imaging system as defined in claim 1 further including an adaptive x-ray dose control system using data received by said collection system to permit adaptive real-time dosage control during the image scanning process.

31) The imaging system as defined in claim 1 further including apparatus permitting the continuous updating of VCT volume imaging data in real-time on interactive displays and operator displays, said apparatus analyzing and processing imaging data in those regions where there have been view to view changes which exceed a predetermined level during the data acquisition process.

32) The imaging system as defined in claim 1 further including an interventional image control system utilizing VCT, DR, PET and NM/SPECT images to control the acquisition of data by said collection system permitting the production of substantially real-time images of invasive procedures on the patient.

33) The imaging system as defined in claim 32 wherein said interventional image control system includes an interventional planning system which allows the planning of interventional procedures and compares real-time actual interventional procedures with planned interventional procedures and corrects said actual interventional procedures to substantially coincide with said planned interventional procedures.

34) The imaging system as defined in claim 33 further including a minimally invasive robotic system to perform minimally invasive surgical procedures, said minimally invasive robotic system being operably controlled by said interventional planning system.

35) The imaging system as defined in claim 1 further including an image analysis system to perform dynamic anatomical, physiological and functional imaging display, fusion and analysis of VCT, DR, PET and NM/SPECT images.

36) The imaging system as defined in claim 1 wherein said configuration of focused two-dimensional curved detector arrays includes an independent channel processing system for achieving high imaging count rates when the system is in the PET and NM/SPECT modes of operation.

37) The imaging system as defined in claim 36 further including a PET time stamping coincidence system for high count rate PET imaging, said PET time stamping coincidence system providing optimal coincidence digital time stamping of a positron generated gamma rays for real time randoms correction derived from average count rate adjustment and delay coincidence window rate.

38) The imaging system as defined in claim 1 further including a PET anti-scatter collimation ring interposed between the patient and said configuration of focused two-dimensional curved detector arrays, said PET anti-scatter collimation ring comprising a set of baffles to reduce out-of-field scatter and to improve the coincidence rate.

39) The imaging system as defined in claim 1 further including a PET transmission attenuation system for whole body PET transmission attenuation correction, said PET transmission attenuation system generating image projection corrections using VCT image and attenuation data.

40) The imaging system as defined in claim 1 further including an NM/SPECT transmission attenuation system for whole body NM/SPECT transmission attenuation correction, said NM/SPECT transmission attenuation system generating image projection corrections using VCT image and attenuation data.

41) The imaging system as defined in claim 1 further including a PET transmission scatter fraction correction system for whole body PET three-dimensional scatter correction, said PET transmission scatter fraction correction system generating projection scatter corrections using VCT image and attenuation data.

42) The imaging system as defined in claim 1 further including an NM/SPECT transmission scatter fraction correction system for whole body NM/SPECT three-dimensional scatter correction, said NM/SPECT transmission scatter fraction correction system generating projection scatter corrections using VCT image and attenuation data.

43) The imaging system as defined in claim 1 further including PET and NM/SPECT detector and imaging apparatus allowing multiple concurrent imaging for PET isotopes and NM/SPECT isotopes.

44) The imaging system as defined in claim 1 further including a shape compensation filter for attenuating cone beam x-ray radiation to minimize patient dosage and to normalize the dynamic range of said configuration of focused two-dimensional curved detector arrays.

45) The imaging system as defined in claim 1 further including a cone beam source collimator for spiral VCT imaging to reduce patient dosage and to substantially eliminate redundant imaging data.

46) The imaging system as defined in claim 1 wherein said at least one gantry is comprised of a first gantry, a second gantry and a third gantry, said first, second and third gantries being operatively attached to one another, and wherein said configuration of focused two-dimensional curved detector arrays is comprised of a first configuration of focused two-dimensional curved detector arrays positioned to detect x-rays produced by said at least one x-ray source when the system is in the VCT and DR modes of operation, a second configuration of focused two-dimensional curved detector arrays positioned to detect coincident gamma rays when the system is in the PET mode of operation, and a third configuration of focused two-dimensional curved detector arrays positioned to detect gamma rays when the system is in the NM/SPECT mode of operation, said table supporting and positioning a patient relative to said first, second and third gantries, said selecting means comprising means for controlling the relative lateral movement of said first, second and third gantries with respect to said table and the rotational movement of said at least one x-ray source and said first configuration of focused two-dimensional curved detector arrays with respect to said first gantry and to said table.

47) The imaging system as defined in claim 1 wherein said at least one gantry is comprised of a first gantry, a second gantry and a third gantry said first, second and third gantries being operatively attached to one another, and wherein said configuration of focused two-dimensional curved detector arrays is comprised of a first configuration of focussed two-dimensional curved detector arrays positioned to detect x-rays produced by said at least one x-ray source when the system is in the VCT and DR modes of operation, a second configuration of focused two-dimensional curved detector arrays positioned to detect coincident gamma rays when the system is in the PET mode of operation, and a third configuration of focused two-dimensional curved detector arrays positioned to detect gamma rays when the system is in the NM/SPECT mode of operation, said table supporting and positioning a patient relative to said first, second and third gantries, said selecting means comprising means for controlling the relative lateral movement of said first, second and third gantries with respect to said table and the rotational movement of said at least one x-ray source with respect to said first configuration of focused two-dimensional curved detector arrays, said first gantry and said table.
